(19) United States
(12) Patent Application Publication
(10) Pub. No.: US 2025/0189185 A1
(43) Pub. Date: Jun. 12, 2025

(54) ROTARY COMPRESSOR AND HOME APPLIANCE INCLUDING THE SAME

(71) Applicant: Samsung Electronics Co., Ltd., Suwon-si (KR)

(72) Inventors: Sedong LEE, Suwon-si (KR); Jongwon CHOI, Suwon-si (KR); Munseong KWON, Suwon-si (KR); Joonhyung KIM, Suwon-si (KR); Jaewoo PARK, Suwon-si (KR)

(21) Appl. No.: 18/825,488

(22) Filed: Sep. 5, 2024

Related U.S. Application Data
(63) Continuation of application No. PCT/KR2024/096072, filed on Aug. 29, 2024.

(30) Foreign Application Priority Data
Dec. 11, 2023 (KR) 10-2023-0178448

(51) Int. Cl. F25B 31/02; F04C 18/356

(52) U.S. Cl. CPC F25B 31/026; F04C 18/3568; F25B 2400/0401

(57) ABSTRACT

A home appliance is provided. The home appliance includes a compressor configured to compress a refrigerant, and a heat pump including a heat exchanger configured to condense or evaporate the refrigerant using the refrigerant compressed by the compressor, wherein the compressor includes a case including a suction port and a discharge port, a compression device configured to compress the refrigerant introduced from the suction port, and a driving device disposed on one side of the compression device and configured to drive the compression device, and wherein the compression device includes a compression chamber providing a space in which the refrigerant is compressed, a suction hole communicating with the suction port, and an insulation chamber positioned outside the compression chamber to be spatially separated from the compression chamber.

### CROSS-REFERENCE TO RELATED APPLICATION(S)

This application is a continuation application, claiming priority under § 365(c), of an International application No. PCT/KR2024/096072, filed on Aug. 29, 2024, which is based on and claims the benefit of a Korean patent application number 10-2023-0178448, filed on Dec. 11, 2023, in the Korean Intellectual Property Office, the disclosure of which is incorporated by reference herein in its entirety.

### BACKGROUND

### Field

The disclosure relates to a rotary compressor and a home appliance including the same.

### Description of Related Art

A compressor is a mechanical device that increases pressure by compressing air, refrigerant, or various other working gases using a motor or turbine. The compressor may be used in various ways throughout the industry, and when used in the refrigerant cycle, the compressor may convert a refrigerant having a low pressure into a refrigerant having a high pressure and transfer the refrigerant back to the condenser. For example, the compressor may be included in various types of home appliances including a heat pump, such as an air conditioner or a refrigerator.

Compressors may be largely divided into the reciprocating compressor in which a compression space where working gas is sucked in and discharged is formed between the piston and the cylinder, and the piston compresses the refrigerant while linearly reciprocating within the cylinder, the scroll compressor in which a compression space where working gas is sucked in and discharged between an orbiting scroll and a fixed scroll is formed, and the orbiting scroll rotates along the fixed scroll to compress the refrigerant, and the rotary compressor in which a compression space where working gas is sucked in and discharged is formed between a rolling piston that rotates eccentrically and the cylinder, and the rolling piston rotates eccentrically along an inner wall of the cylinder to compress the refrigerant.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a rotary compressor and a home appliance including the same to reduce heat loss of the rotary compressor and enhance volumetric efficiency.

Additional aspects will be set forth in part in the description which follows and, in part, will be apparent from the description, or may be learned by practice of the presented embodiments.

In accordance with an aspect of the disclosure, a home appliance is provided. The home appliance includes a compressor configured to compress a refrigerant, and a heat pump including a heat exchanger configured to condense or evaporate the refrigerant using the refrigerant compressed by the compressor, wherein the compressor includes a case including a suction port and a discharge port, a compression device configured to compress the refrigerant introduced from the suction port, and a driving device disposed on one side of the compression device and configured to drive the compression device, wherein and the compression device includes a compression chamber providing a space in which the refrigerant is compressed, a suction hole communicating with the suction port, and an insulation chamber positioned outside the compression chamber to be spatially separated from the compression chamber.

In accordance with another aspect of the disclosure, a rotary compressor is provided. The rotary compressor reduces heat loss of the compressor by forming a bypass flow path through which a portion of the refrigerant passing through the suction port of the compression device may bypass and accommodating the refrigerant in a chamber provided outside the compression chamber.

In accordance with an aspect of the disclosure, a compressor, including a case including a suction port and a discharge port, a compression device configured to compress a refrigerant introduced from the suction port, and a driving device disposed on one side of the compression device and configured to drive the compression device, wherein the compression device includes a compression chamber providing a space in which the refrigerant is compressed, a suction hole communicating with the suction port, and an insulation chamber positioned outside the compression chamber to be spatially separated from the compression chamber.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a view illustrating an exterior of an air conditioner according to an embodiment;

FIG. 1B is a view illustrating an exterior of an air conditioner according to an embodiment;

FIG. 2 is a view schematically illustrating a configuration related to a refrigerant cycle of an air conditioner according to an embodiment;

FIG. 3 is a perspective view illustrating a compressor according to an embodiment;

FIG. 4 is a cross-sectional view illustrating a compressor according to an embodiment;

FIG. 5 is a top perspective view illustrating a compression device according to an embodiment;

FIG. 6 is a bottom perspective view illustrating a compression device according to an embodiment;

FIG. 7 is a top view illustrating a compression device according to an embodiment;

FIG. 8 is a perspective view illustrating a first flange according to an embodiment;

FIG. 9 is an exploded perspective view illustrating a first flange according to an embodiment;

FIGS. 10A and 10B are perspective views illustrating a first cylinder according to an embodiment;

FIG. 11 is a cross-sectional view illustrating a compression device according to an embodiment;

FIG. 12 is a perspective view illustrating a refrigerator according to an embodiment;

FIG. 13 is a view schematically illustrating a heat pump structure included in a refrigerator according to an embodiment of the disclosure;

FIG. 14 is a front perspective view illustrating a clothing dryer according to an embodiment; and

FIG. 15 is a cross-sectional view illustrating a clothing dryer according to an embodiment.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

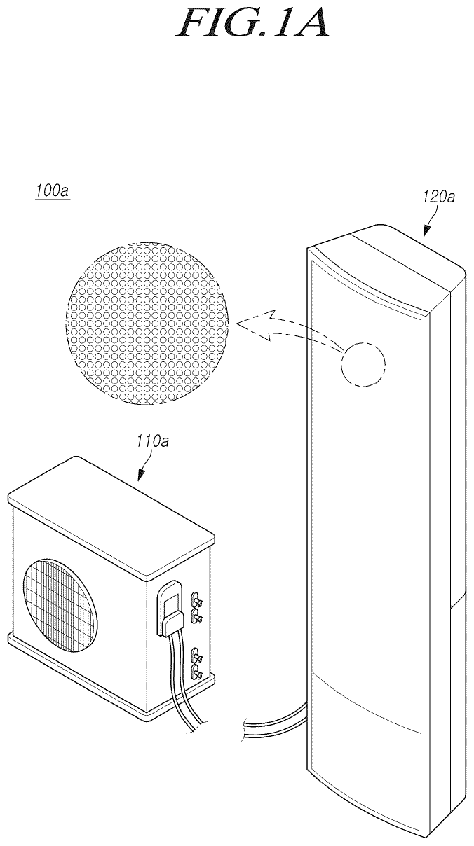

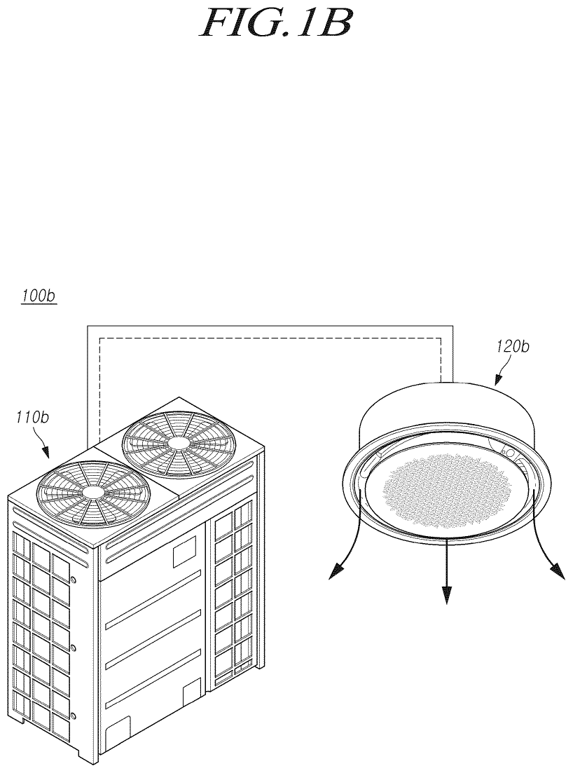

Various embodiments of the disclosure are merely exemplified herein with reference to FIGS. 1A, 1B, 2 to 9, 10A, 10B, and 11 to 15, to describe the principle of the disclosure, and should not be interpreted as limiting the scope of the disclosure. Those skilled in the art will understand that the principle of the disclosure may be implemented in any appropriately disposed system or device.

It should be appreciated that various embodiments of the disclosure and the terms used therein are not intended to limit the technological features set forth herein to particular embodiments and include various changes, equivalents, or replacements for a corresponding embodiment.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

The term “and/or” may denote a combination(s) of a plurality of related components as listed or any of the components.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

An air conditioner according to various embodiments is a device that performs functions such as air purification, ventilation, humidity control, cooling, or heating in an air conditioning space (hereinafter referred to as “indoor”), and means a device having at least one of the functions.

According to an embodiment, the air conditioner may include a heat pump device to perform a cooling function or a heating function. The heat pump device may include a cooling cycle in which the refrigerant is circulated along the compressor, the first heat exchanger, the expansion device, and the second heat exchanger. All of the components of the heat pump device may be embedded in one housing forming the exterior of the air conditioner, and a window air conditioner or a portable air conditioner corresponds to such an air conditioner. On the other hand, some components of the heat pump device may be separately embedded in the plurality of housings forming one air conditioner, including a wall-mounted air conditioner, a standing air conditioner, a ceiling-mount air conditioner, a system air conditioner, and the like.

An air conditioner including a plurality of housings may include at least one outdoor unit installed outdoors and at least one indoor unit installed indoors. For example, the air conditioner is provided so that one outdoor unit and one indoor unit are connected through a refrigerant pipe. For example, the air conditioner is provided so that one outdoor unit is connected to two or more indoor units through the refrigerant pipe. For example, the air conditioner is provided so that two or more outdoor units and two or more indoor units are connected through a plurality of refrigerant pipes.

The outdoor unit may be electrically connected to the indoor unit. For example, information (or a command) for controlling the air conditioner is input through an input interface provided in the outdoor unit or the indoor unit, and the outdoor unit and the indoor unit may operate simultaneously or sequentially in response to a user input.

The air conditioner may include an outdoor heat exchanger provided in the outdoor unit, an indoor heat exchanger provided in the indoor unit, and a refrigerant pipe connecting the outdoor heat exchanger and the indoor heat exchanger.

The outdoor heat exchanger may perform heat exchange between the refrigerant and outdoor air by phase change of the refrigerant (e.g., evaporation or condensation). For example, while the refrigerant is condensed in the outdoor heat exchanger, the refrigerant emits heat to the outdoor air, and while the refrigerant flowing in the outdoor heat exchanger evaporates, the refrigerant may absorb heat from the outdoor air.

The indoor unit is provided indoors. For example, the indoor unit is classified as a ceiling type indoor unit, a stand type indoor unit, a wall-mounted type indoor unit, or the like according to how to mount. For example, the ceiling type indoor unit is classified as a 4-way type indoor unit, a 1-way type indoor unit, a duct type indoor unit, or the like according to a method in which air is discharged.

Likewise, the indoor heat exchanger may perform heat exchange between the refrigerant and the indoor air by phase change of the refrigerant (e.g., evaporation or condensation). For example, while the refrigerant evaporates in the indoor unit, the refrigerant absorbs heat from the indoor air, and the room may be cooled by blowing the cooled indoor air while passing through the cooled indoor heat exchanger. Further, while the refrigerant is condensed in the indoor heat exchanger, the refrigerant may emit heat to the indoor air, and the indoor space may be heated by blowing the heated indoor air while passing through the high-temperature indoor heat exchanger.

In other words, the air conditioner performs a cooling or heating function through the phase change process of the refrigerant circulating between the outdoor heat exchanger and the indoor heat exchanger, and for the circulation of the refrigerant, the air conditioner may include a compressor for compressing the refrigerant. The compressor may suck the refrigerant gas through the suction unit and compress the refrigerant gas. The compressor may discharge high-temperature and high-pressure refrigerant gas through the discharge unit. The compressor may be disposed inside the outdoor unit.

The refrigerant may circulate through the refrigerant pipe in the order of the compressor, the outdoor heat exchanger, the expansion device, and the indoor heat exchanger, or may circulate in the order of the compressor, the indoor heat exchanger, the expansion device, and the outdoor heat exchanger.

For example, in the air conditioner, when one outdoor unit and one indoor unit are directly connected through the refrigerant pipe, the refrigerant is provided to circulate between the one outdoor unit and the one indoor unit through the refrigerant pipe.

For example, when one outdoor unit of the air conditioner is connected to two or more indoor units through a refrigerant pipe, the refrigerant flows to the plurality of indoor units through the refrigerant pipe branching from the outdoor unit. The refrigerant discharged from the plurality of indoor units may be provided to be joined and circulated to the outdoor unit. For example, each of the plurality of indoor units is directly connected to one outdoor unit in parallel through a separate refrigerant pipe.

Each of the plurality of indoor units may operate independently according to an operation mode set by the user. In other words, some of the plurality of indoor units may operate in the cooling mode, and at the same time, others may operate in the heating mode. In this case, the refrigerant may be selectively introduced into each indoor unit in a high-pressure or low-pressure state along a designated circulation path through a flow path switching valve to be described below, and may be discharged and circulated to the outdoor unit.

For example, when two or more outdoor units and two or more indoor units are connected through a plurality of refrigerant pipes, the refrigerant discharged from the plurality of outdoor units are joined to flow through one refrigerant pipe, and then branched again at some point to flow into the plurality of indoor units.

All of the plurality of outdoor units may be driven or at least some of the plurality of outdoor units may not be driven according to the operation load according to the operation amount of the plurality of indoor units. In this case, the refrigerant may be provided to flow into and circulate through the outdoor unit selectively driven through the flow path switching valve. The air conditioner may include an expansion device to lower the pressure of the refrigerant flowing into the heat exchanger. For example, the expansion device is disposed inside the indoor unit or the outdoor unit, or may be disposed in both.

The expansion device may lower the temperature and pressure of the refrigerant by using, e.g., a throttling effect. The expansion device may include an orifice capable of reducing the cross-sectional area of the flow path. The refrigerant passing through the orifice may decrease in temperature and pressure.

The expansion device may be implemented as, e.g., an electronic expansion device capable of adjusting an opening ratio (the ratio of the cross-sectional area of the flow path of the valve in the partially opened state to the cross-sectional area of the flow path of the valve in the fully opened state). The amount of refrigerant passing through the expansion device may be controlled depending on the opening ratio of the electronic expansion device.

The air conditioner may further include a flow path switching valve disposed on the refrigerant circulation flow path. The flow path switching valve may include, e.g., a four-way valve. The flow path switching valve may determine the circulation path of the refrigerant depending on the operation mode (e.g., a cooling operation or a heating operation) of the indoor unit. The flow path switching valve may be connected to the discharge unit of the compressor.

The air conditioner may include an accumulator. The accumulator may be connected to the suction unit of the compressor. The low-temperature and low-pressure refrigerant evaporated from the indoor heat exchanger or the outdoor heat exchanger may be introduced into the accumulator.

The accumulator may separate the refrigerant liquid from the refrigerant gas when the mixed refrigerant of the refrigerant liquid and the refrigerant gas is introduced, and provide the refrigerant gas from which the refrigerant liquid is separated to the compressor.

An outdoor fan may be provided near the outdoor heat exchanger. The outdoor fan may blow outdoor air to the outdoor heat exchanger to promote heat exchange between the refrigerant and the outdoor air.

The outdoor unit of the air conditioner may include at least one sensor. For example, the sensor of the outdoor unit is provided as an environmental sensor. The outdoor unit sensor may be disposed at any position inside or outside the outdoor unit. For example, the outdoor unit sensor includes, e.g., a temperature sensor for detecting the temperature around the outdoor unit, a humidity sensor for detecting the air humidity around the outdoor unit, a refrigerant temperature sensor for detecting the refrigerant temperature of the refrigerant pipe passing through the outdoor unit, or a refrigerant pressure sensor for detecting the refrigerant pressure of the refrigerant pipe passing through the outdoor unit.

The outdoor unit of the air conditioner may include an outdoor unit communication unit. The outdoor unit communication unit may be provided to receive a control signal from the controller of the indoor unit of the air conditioner to be described below. The outdoor unit may control the operation of the compressor, the outdoor heat exchanger, the expansion device, the flow path switching valve, the accumulator, or the outdoor fan based on the control signal received through the outdoor unit communication unit. The outdoor unit may transmit the sensing value detected from the outdoor unit sensor to the controller of the indoor unit through the outdoor unit communication unit.

The indoor unit of the air conditioner may include a housing, a blower for circulating air to the inside or outside of the housing, and an indoor heat exchanger for exchanging heat with air introduced into the housing.

The housing may include a suction port. Indoor air may be introduced into the housing through the suction port.

The indoor unit of the air conditioner may include a filter provided to filter foreign substances in the air introduced into the housing through the suction port.

The housing may include a discharge port. Air flowing inside the housing may be discharged to the outside of the housing through the discharge port.

An airflow guide for guiding the direction of air discharged through the discharge port may be provided in the housing of the indoor unit. For example, the airflow guide includes a blade positioned on the discharge port. For example, the airflow guide includes an auxiliary fan for adjusting the discharge airflow. The disclosure is not limited thereto, and the airflow guide may be omitted.

Inside the housing of the indoor unit, an indoor heat exchanger and a blower disposed on the flow path connecting the suction port and the discharge port may be provided.

The blower may include an indoor fan and a fan motor. For example, the indoor fan includes an axial flow fan, a mixed flow fan, a crossflow fan, or a centrifugal fan.

The indoor heat exchanger may be disposed between the blower and the discharge port, or may be disposed between the suction port and the blower. The indoor heat exchanger may absorb heat from the air introduced through the suction port or transfer heat to the air introduced through the suction port. The indoor heat exchanger may include a heat exchange tube through which the refrigerant flows, and a heat exchange fin in contact with the heat exchange tube to increase the heat transfer area.

The indoor unit of the air conditioner may include a drain tray disposed under the indoor heat exchanger to collect condensate generated in the indoor heat exchanger. Condensate accommodated in the drain tray may be drained to the outside through a drain hose. The drain tray may be provided to support the indoor heat exchanger.

The indoor unit of the air conditioner may include an input interface. The input interface may include any type of user input means including buttons, switches, touch screens and/or touch pads. The user may directly input setting data (e.g., desired indoor temperature, operation mode setting of cooling/heating/dehumidification/air cleaning, discharge port selection setting, and/or air volume setting) through the input interface.

The input interface may be connected to an external input device. For example, the input interface is electrically connected to a wired remote controller. The wired remote controller may be installed at a specific position (e.g., a portion of the wall surface) of the indoor space. The user may input setting data regarding the operation of the air conditioner by manipulating the wired remote controller. An electrical signal corresponding to the setting data obtained through the wired remote controller may be transmitted to the input interface. Further, the input interface may include an infrared sensor. The user may remotely input setting data regarding the operation of the air conditioner using a wireless remote controller. The setting data input through the wireless remote controller may be transmitted to the input interface as an infrared signal.

Further, the input interface may include a microphone. The user's voice command may be obtained through the microphone. The microphone may convert the user's voice command into an electrical signal and transfer the converted electrical signal to the indoor unit controller. The indoor unit controller may control the components of the air conditioner to execute the function corresponding to the user's voice command. The setting data (e.g., desired indoor temperature, operation mode setting of cooling/heating/dehumidification/air cleaning, discharge port selection setting, and/or air volume setting) obtained through the input interface may be transferred to the indoor unit controller to be described below. In an example, the setting data obtained through the input interface may be transmitted to the outside, i.e., the outdoor unit or the server, through the indoor unit communication unit to be described below.

The indoor unit of the air conditioner may include a power module. The power module may be connected to an external power source to supply power to components of the indoor unit.

The indoor unit of the air conditioner may include an indoor unit sensor. The indoor unit sensor may be an environmental sensor disposed in a space inside or outside the housing. For example, the indoor unit sensor includes one or more temperature sensors and/or humidity sensors disposed in a predetermined space inside or outside the housing of the indoor unit. For example, the indoor unit sensor includes a refrigerant temperature sensor for detecting the refrigerant temperature of the refrigerant pipe passing through the indoor unit. For example, the indoor unit sensor includes a refrigerant temperature sensor that detects the temperature of the entrance, middle, and/or exit of the refrigerant pipe passing through the indoor heat exchanger.

For example, each environmental information detected by the indoor unit sensor is transferred to the indoor unit controller to be described below, or may be transferred to the outside through the indoor unit communication unit to be described below.

The indoor unit of the air conditioner may include an indoor unit communication unit. The indoor unit communication unit may include at least one of a short-range communication module or a long-range communication module. The indoor unit communication unit may include at least one antenna for wirelessly communicating with another device. The outdoor unit may include an outdoor unit communication unit. The outdoor unit communication unit may also include at least one of a short-range communication module or a long-range communication module.

The short-range wireless communication module may include, but is not limited to, a Bluetooth communication module, a Bluetooth low energy (BLE) communication module, a near field communication module, a WLAN (Wi-Fi) communication module, a Zigbee communication module, an infrared data association (IrDA) communication module, a Wi-Fi direct (WFD) communication module, an ultrawideband (UWB) communication module, an Ant+ communication module, and a microwave (uWave) communication module.

The long-range communication module may include a communication module that performs various types of long-range communication, and may include a mobile communication unit. The mobile communication unit transmits and receives a wireless signal to and from at least one of a base station, an external terminal, and a server over a mobile communication network.

The indoor unit communication unit may communicate with an external device such as a server, a mobile device, another home appliance, or the like through an access point (AP). The AP may connect a local area network (LAN) to which an air conditioner or a user device is connected to a wide area network (WAN) to which a server is connected. The air conditioner or the user device may be connected to the server through a wide area network (WAN). The indoor unit of the air conditioner may include an indoor unit controller for controlling components of the indoor unit including a blower or the like. The outdoor unit of the air conditioner may include an outdoor unit controller for controlling components of the outdoor unit including a compressor or the like. The indoor unit controller may communicate with the outdoor unit controller through the indoor unit communication unit and the outdoor unit communication unit. The outdoor unit communication unit may transfer a control signal generated by the outdoor unit controller to the indoor unit communication unit, or transfer a control signal transferred from the indoor unit communication unit to the outdoor unit controller. In other words, the outdoor unit and the indoor unit may communicate in both directions. The outdoor unit and the indoor unit may transmit and receive various signals generated during the operation of the air conditioner.

The outdoor unit controller may be electrically connected to the components of the outdoor unit and may control the operation of each component. For example, the outdoor unit controller adjusts the frequency of the compressor and control the flow path switching valve to change the circulation direction of the refrigerant. The outdoor unit controller may adjust the rotational speed of the outdoor fan. Further, the outdoor unit controller may generate a control signal for adjusting the opening degree of the expansion device. Under the control of the outdoor unit controller, the refrigerant may circulate along the refrigerant circulation circuit including the compressor, the flow path switching valve, the outdoor heat exchanger, the expansion device, and the indoor heat exchanger.

Various temperature sensors included in the outdoor unit and the indoor unit may transmit an electrical signal corresponding to the detected temperature to each of the outdoor unit controller and/or the indoor unit controller. For example, the humidity sensors included in the outdoor unit and the indoor unit may transmits an electrical signal corresponding to the detected humidity to the outdoor unit controller and/or the indoor unit controller.

The indoor unit controller may obtain a user input from a user device including a mobile device or the like through the indoor unit communication unit, and may obtain the user input directly through the input interface or through a remote controller. The indoor unit controller may control components of the indoor unit including a blower or the like in response to the received user input. The indoor unit controller may transmit the received user input information to the outdoor unit controller of the outdoor unit.

The outdoor unit controller may control components of the outdoor unit including a compressor or the like based on the user input information received from the indoor unit. For example, when the control signal corresponding to the user input for selecting the operation mode such as the cooling operation, the heating operation, the blowing operation, the defrosting operation, or the dehumidification operation is received from the indoor unit, the outdoor unit controller controls the components of the outdoor unit to perform the operation of the air conditioner corresponding to the selected operation mode.

Each of the outdoor unit controller and the indoor unit controller may include a processor and a memory. The indoor unit controller may include at least one first processor and at least one first memory, and the outdoor unit controller may include at least one second processor and at least one second memory.

The memory may record/store various types of information necessary for the operation of the air conditioner. The memory may store instructions, applications, data, and/or programs necessary for the operation of the air conditioner. For example, the memory stores various programs for the cooling operation, the heating operation, the dehumidification operation, and/or the defrosting operation of the air conditioner. The memory may include a volatile memory such as a static random access memory (S-RAM) and a dynamic random access memory (D-RAM) for temporarily storing data. Further, the memory may include a non-volatile memory such as a read only memory (ROM), an erasable programmable read only memory (EPROM), and an electrically erasable programmable read only memory (EEPROM) for storing data for a long time.

The processor may generate a control signal for controlling the operation of the air conditioner based on instructions, applications, data, and/or programs stored in the memory. The processor may include a logic circuit and an operation circuit as hardware. The processor may process data according to a program and/or instruction provided from the memory, and generate a control signal according to a processing result. The memory and the processor may be implemented as a single control circuit or a plurality of circuits.

The indoor unit of the air conditioner may include an output interface. The output interface may be electrically connected to the indoor unit controller and output information related to the operation of the air conditioner under the control of the indoor unit controller. For example, information such as the operation mode, the wind direction, the wind volume, and the temperature selected by the user input may be output. The output interface may output sensing information and a warning/error message obtained from the indoor unit sensor or the outdoor unit sensor.

The output interface may include a display and a speaker. The speaker may output various sounds as an acoustic device. The display may display information input by the user or information provided to the user as various graphic elements. For example, operation information about the air conditioner is displayed as at least one of an image or text. Further, the display may include an indicator that provides specific information. The display may include a liquid crystal display (LCD) panel, a light emitting diode (LED) panel, an organic light emitting diode (OLED) panel, a micro LED panel, and/or a plurality of LEDs.

FIG. 1A is a view illustrating an exterior of an air conditioner according to an embodiment;

FIG. 1B is a view illustrating an exterior of an air conditioner according to an embodiment;

FIGS. 1A and 1B are for describing a type of an air conditioner, and the scope of the disclosure is not limited to the illustrated type of the air conditioner.

Referring to FIGS. 1A and 1B, an air conditioner 100a and 100b may include an outdoor unit 110a and 110b and an indoor unit 120a and 120b. The outdoor unit 110a and 110b may be provided in an outdoor space to perform heat exchange between the outdoor air and the refrigerant. The indoor unit 120a and 120b may be provided in an indoor space to perform heat exchange between the indoor air and the refrigerant.

The outdoor unit 110a and 110b may be positioned outside the air conditioning space. The indoor unit 120a and 120b may be positioned in the air conditioning space. The air conditioning space may refer to a space that is cooled or heated by the air conditioner 100a and 100b. For example, the air conditioning space is an indoor space.

For example, the outdoor unit 110a and 110b is disposed outside the building. For example, the indoor unit 120a and 120b is disposed in a space separated from the outside by a wall, such as a living room or an office.

FIG. 1A illustrates an air conditioner 100a (i.e., a floor standing air conditioner), and FIG. 1B illustrates an air conditioner 100b (i.e., a system air conditioner). The refrigerant circulation structure of the heat pump and the structure of the compressor included in the heat pump, which is described below, may be included in various types of air conditioners as well as the types of air conditioners 100a and 100b illustrated in FIGS. 1A and 1B.

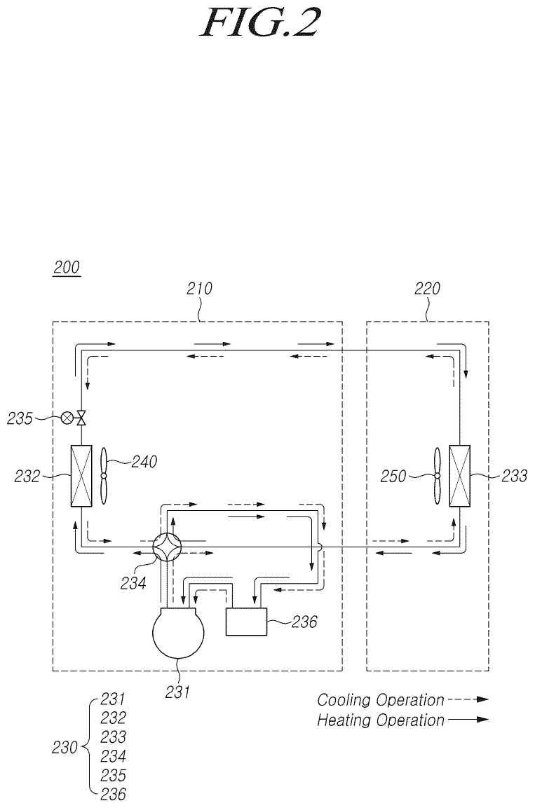

FIG. 2 is a view schematically illustrating a configuration related to a refrigerant cycle of an air conditioner according to an embodiment.

In FIG. 2, an air conditioner 200, which is one of home appliances, is described as an example.

Referring to FIG. 2, the air conditioner 200 may include a heat pump 230. The refrigerant cycle of the air conditioner 200 may be performed by the heat pump 230. The air conditioner 200 illustrated in FIG. 2 may be substantially the same as the air conditioner 100a or 100b of FIG. 1A or 1B. The heat pump 230 of the air conditioner 200 illustrated in FIG. 2 may be included in the air conditioner 100a or 100b of FIG. 1A or 1B.

According to an embodiment, the air conditioner 200 may include a refrigerant flow path for circulating the refrigerant between the outdoor unit 210 and the indoor unit 220. The refrigerant may circulate between the indoor unit 220 and the outdoor unit 210 along the refrigerant flow path, and may absorb heat or emit heat through phase change (e.g., phase change from gas to liquid or phase change from liquid to gas).

According to an embodiment, the air conditioner 200 may include a liquid pipe P1 and a gas pipe P2 provided to circulate the refrigerant. The liquid pipe P1 may be a pipe connecting the outdoor unit 210 and the indoor unit 220 and serving as a passage through which the liquid refrigerant flows. The gas pipe P2 may be a pipe connecting the outdoor unit 210 and the indoor unit 220 and serving as a passage through which the gaseous refrigerant flows. Each of the liquid pipe P1 and the gas pipe P2 may extend into the outdoor unit 210 and the indoor unit 220.

According to an embodiment, the heat pump 230 may include at least one of a compressor 231, an outdoor heat exchanger 232, an indoor heat exchanger 233, a four-way valve 234, an expansion device 235, or an accumulator 236. The compressor 231 may be configured to compress the refrigerant. The outdoor heat exchanger 232 may perform heat exchange between the outdoor air and the refrigerant. The indoor heat exchanger 233 may perform heat exchange between the indoor air and the refrigerant. The four-way valve 234 may be configured to guide the refrigerant compressed by the compressor 231 to the outdoor heat exchanger 232 or the indoor heat exchanger 233 based on the cooling operation or the heating operation. The expansion device 235 may be configured to decompress the refrigerant. The accumulator 236 may be configured to prevent a liquid refrigerant that has not been evaporated from flowing into the compressor 231.

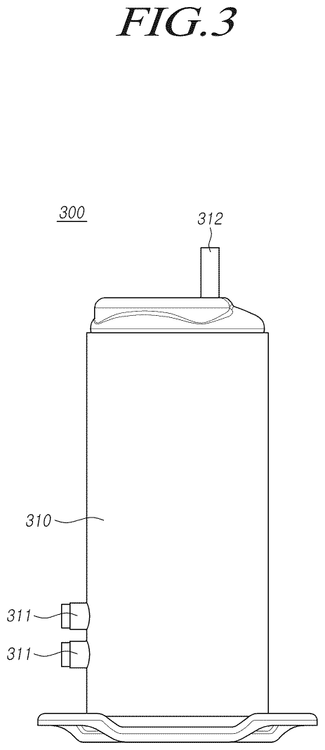

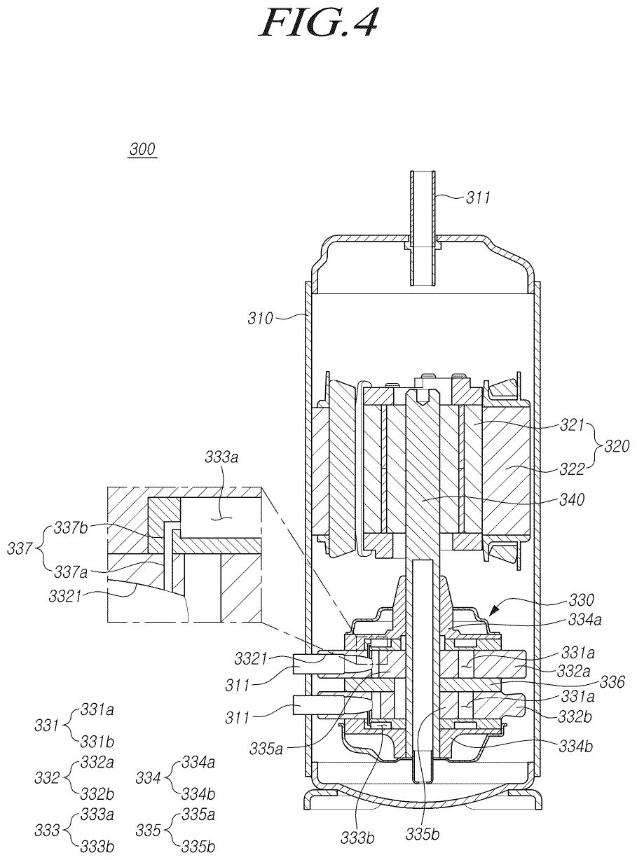

According to an embodiment, the compressor 231 may operate by receiving electrical energy from an external power source. The compressor 231 may include a compressor motor (e.g., the driving device 320 of FIG. 4), and may compress a low-pressure gaseous refrigerant to a high pressure using a rotational force of the compressor motor (e.g., the driving device 320 of FIG. 4). The compressor 231 is described in detail below with reference to FIG. 3.

According to an embodiment, the four-way valve 234 may be adjusted to guide the refrigerant compressed by the compressor 231 to the outdoor heat exchanger 232 during the cooling operation. According to an embodiment, the four-way valve 234 may be adjusted to guide the refrigerant compressed by the compressor 231 to the indoor heat exchanger 233 during the heating operation.

According to an embodiment, the outdoor heat exchanger 232 may condense the refrigerant compressed by the compressor 231 during the cooling operation. According to an embodiment, the outdoor heat exchanger 232 may evaporate the refrigerant decompressed by the indoor unit 220 (or the indoor heat exchanger 233) during the heating operation. The outdoor heat exchanger 232 may include an outdoor heat exchanger refrigerant pipe through which the refrigerant passes and an outdoor heat exchanger cooling fin for increasing the surface area with which outdoor air comes into contact. When the surface area in which the outdoor heat exchanger refrigerant pipe and the outdoor air come into contact with each other is increased, heat exchange efficiency between the refrigerant and the outdoor air may be enhanced.

According to an embodiment, the air conditioner 200 may include an outdoor blower fan 240. According to an embodiment, the outdoor unit 210 may include an outdoor blower fan 240. The outdoor blower fan 240 may be disposed around the outdoor heat exchanger 232 to flow outdoor air to the outdoor heat exchanger 232. Here, the outdoor air may refer to air outside the outdoor unit 210. The outdoor blower fan 240 may blow outdoor air before heat exchange to the outdoor heat exchanger 232. The outdoor blower fan 240 may blow air heat-exchanged with the outdoor heat exchanger 232 to the outdoor.

According to an embodiment, the expansion device 235 may decompress the refrigerant. According to an embodiment, the expansion device 235 may adjust the amount of refrigerant provided from the outdoor heat exchanger 232 so that sufficient heat exchange is performed in the outdoor heat exchanger 232. For example, when the refrigerant passes through a narrow flow path, the expansion device 235 decompresses the refrigerant using a throttling action of the refrigerant, the pressure of which decreases without heat exchange with the outside. In order to adjust the amount of refrigerant passing through the expansion device 235, an electronic expansion valve (EEV) capable of adjusting the opening degree may be used.

According to an embodiment, the indoor heat exchanger 233 may evaporate the low-pressure liquid refrigerant during the cooling operation. According to an embodiment, the indoor heat exchanger 233 may condense the high-pressure gaseous refrigerant during the heating operation. Like the outdoor heat exchanger 232 of the outdoor unit 210, the indoor heat exchanger 233 may include an indoor heat exchanger refrigerant pipe through which the refrigerant passes and an indoor heat exchanger cooling fin for enhancing heat exchange efficiency between the refrigerant and indoor air.

According to an embodiment, the air conditioner 200 may include an indoor blower fan 250. According to an embodiment, the indoor unit 220 may include an indoor blower fan 250. The indoor blower fan 250 may be disposed around the indoor heat exchanger 233 to flow indoor air to the indoor heat exchanger 233. Here, indoor air may refer to air outside the indoor unit 220. The indoor blower fan 250 may blow indoor air before heat exchange to the indoor heat exchanger 233. The indoor blower fan 250 may blow air heat-exchanged with the indoor heat exchanger 233 into the room.

According to an embodiment, during the cooling operation, the refrigerant may emit heat from the outdoor heat exchanger 232 and absorb heat from the indoor heat exchanger 233. For example, during the cooling operation, the refrigerant compressed by the compressor 231 is first supplied to the outdoor heat exchanger 232 through the four-way valve 234 and then supplied to the indoor heat exchanger 233. In this case, the outdoor heat exchanger 232 may operate as a condenser for condensing the refrigerant. The indoor heat exchanger 233 may operate as an evaporator for evaporating the refrigerant.

According to an embodiment, during the cooling operation, the high-temperature and high-pressure gaseous refrigerant discharged from the compressor 231 may move to the outdoor heat exchanger 232, the refrigerant in liquid phase condensed in the outdoor heat exchanger 232 or the refrigerant close to the liquid phase may be expanded and decompressed by the expansion device 235, and the two-phase refrigerant passing through the expansion device 235 may move to the indoor heat exchanger 233. The refrigerant introduced into the indoor heat exchanger 233 may be evaporated by exchanging heat with air. Therefore, the temperature of the heat-exchanged air may decrease and cold air may be discharged to the outside of the indoor unit 220.

According to an embodiment, during the heating operation, the refrigerant may emit heat from the indoor heat exchanger 233 and absorb heat from the outdoor heat exchanger 232. For example, during the heating operation, the refrigerant compressed by the compressor 231 is first supplied to the indoor heat exchanger 233 through the four-way valve 234 and then to the outdoor heat exchanger 232. In this case, the indoor heat exchanger 233 may operate as a condenser for condensing the refrigerant. The outdoor heat exchanger 232 may operate as an evaporator for evaporating the refrigerant.

According to an embodiment, during the heating operation, the high-temperature and high-pressure gaseous refrigerant discharged from the compressor 231 may move to the indoor heat exchanger 233, and the high-temperature and high-pressure gaseous refrigerant passing through the indoor heat exchanger 233 may exchange heat with the low-temperature air. The refrigerant may be condensed into a liquid refrigerant or a refrigerant close to the liquid refrigerant to discharge heat, and the air absorbs heat to discharge warm air to the outside of the indoor unit 220.

FIG. 3 is a perspective view illustrating a compressor according to an embodiment.

FIG. 4 is a cross-sectional view illustrating a compressor according to an embodiment.

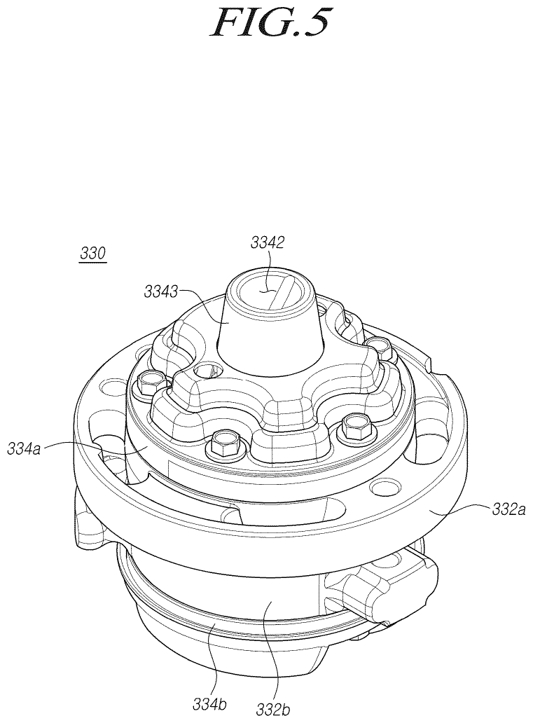

FIG. 5 is a top perspective view illustrating a compression device according to an embodiment;

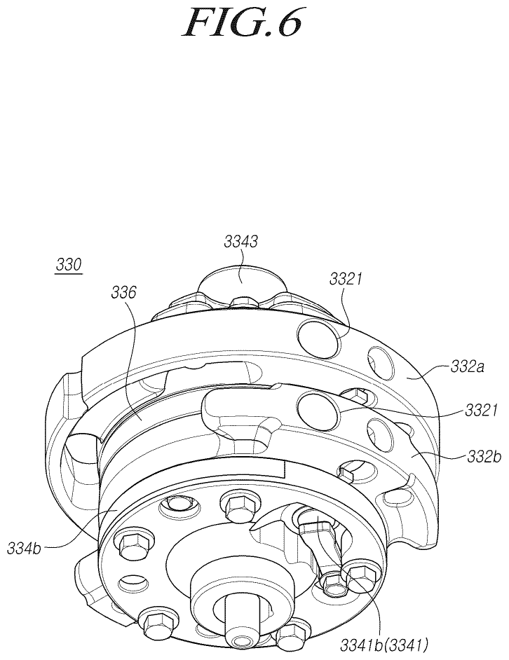

FIG. 6 is a bottom perspective view illustrating a compression device according to an embodiment;

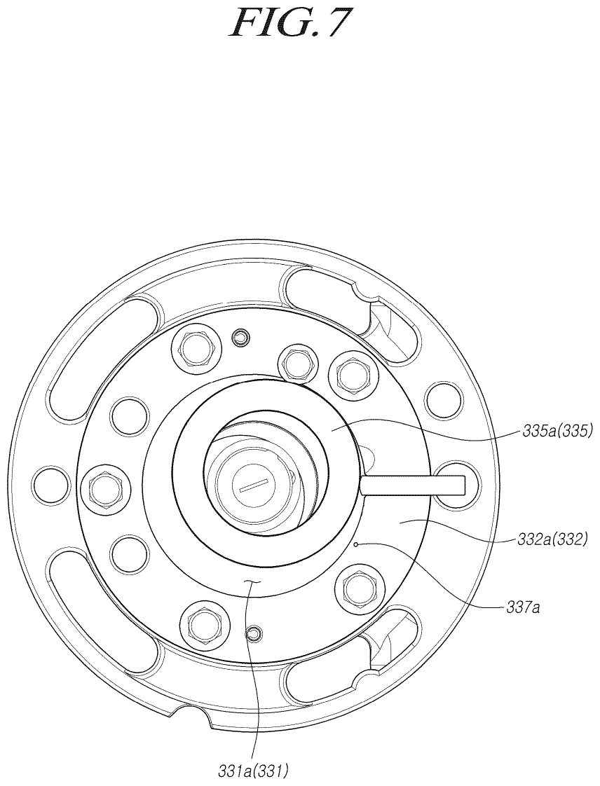

FIG. 7 is a top view illustrating a compression device according to an embodiment;

The compressor 300 illustrated in FIGS. 3 to 7 may be substantially the same as the compressor (e.g., the compressor 231 of FIG. 2) of the air conditioner (e.g., the air conditioner 200 of FIG. 2) of FIG. 2. The compressor 300 illustrated in FIGS. 3 to 7 may be included in the air conditioner 200 of FIG. 2. The structure of the compressor 300 illustrated in FIGS. 3 to 7 may be included in the compressor 231 of the air conditioner 200 of FIG. 2.

Referring to FIGS. 3 to 7, the compressor 300 may include a case 310, a driving device 320, a compression device 330, and a rotation shaft 340. The case 310 may be formed to accommodate the driving device 320 and the compression device 330 therein.

According to an embodiment, the case 310 may include a suction port 311 and a discharge port 312. The suction port 311 may be a port through which a gaseous refrigerant passing through an accumulator (e.g., the accumulator 236 of FIG. 2) is introduced. The discharge port 312 may be a port through which the refrigerant compressed by the compression device 330 is discharged.

According to an embodiment, the driving device 320 may be disposed in the case 310 to drive the compression device 330.

According to an embodiment, the driving device 320 may include a rotor 321 and a stator 322. The rotor 321 may be disposed to surround a portion of the rotation shaft 340. The stator 322 may rotatably support the rotor 321.

According to an embodiment, the rotation shaft 340 may be disposed to connect the driving device 320 and the compression device 330. The rotation shaft 340 may be rotated by the driving device 320. The rotated rotation shaft 340 may be configured to transfer rotational power to the compression device 330. The rotation shaft 340 may be disposed to pass through, e.g., a portion of the compression device 330. For example, one end portion of the rotation shaft 340 is positioned in the compression chamber 331 of the compression device 330 to be described below.

According to an embodiment, the rotation shaft 340 may be coupled to the rolling piston 335 disposed in the compression chamber 331. The rotation shaft 340 may transfer the rotational force of the driving device 320 to the rolling piston 335.

According to an embodiment, the compression device 330 may include at least one of a compression chamber 331, a suction hole 3321, or an insulation chamber 333. The compression chamber 331 may be a space formed to compress the refrigerant.

According to an embodiment, the suction hole 3321 may communicate with the suction port 311 of the case 310. The low-pressure gaseous refrigerant introduced through the suction port 311 may be introduced into the compression chamber 331 through the suction hole 3321. The low-pressure gaseous refrigerant introduced into the compression chamber 331 may be compressed into a high-temperature and high-pressure state and then discharged to the outside.

According to an embodiment, the insulation chamber 333 may be formed outside the compression chamber 331. The insulation chamber 333 may be spatially separated from the compression chamber. The insulation chamber 333 may be positioned on, e.g., at least one of an upper side or a lower side of the compression chamber 331. The conductive thermal resistance of the insulation chamber 333 may be relatively larger than that of the flange 334 to be described below. The insulation chamber 333 may be disposed around the compression chamber 331 to increase conductive thermal resistance around the compression chamber 331.

A high temperature may be formed in the space between the case 310 and the compression device 330 by the high-temperature and high-pressure discharge refrigerant. When high-temperature heat outside the compression device 330 heats the compression chamber 331, heat loss may increase and volumetric efficiency may decrease accordingly. In the disclosure, the conductive thermal resistance of the compression device 330 (e.g., the flange 334) may be increased by forming the insulation chamber 333 in an empty space around the compression chamber 331. As a result, the degree to which the temperature of the compression chamber 331 increases due to the heat outside the compression device 330 may be reduced, and the heat loss may be reduced to enhance volumetric efficiency.

According to an embodiment, the compression device 330 may include at least one of a cylinder 332, a flange 334, or a rolling piston 335.

According to an embodiment, the compression chamber 331 may be disposed inside the cylinder 332. For example, the inner circumferential surface of the cylinder 332 defines or partition a side surface of the compression chamber 331. The cylinder 332 may be coupled to the flange 334. According to an embodiment, the cylinder 332 may include a suction hole 3321. The suction hole 3321 may be formed through the cylinder 332. The suction hole 3321 may be formed to penetrate between the inner circumferential surface and the outer circumferential surface of the cylinder 332.

According to an embodiment, the flange 334 may be coupled to the cylinder 332. The flange 334 may be coupled to an upper side or a lower side of the cylinder 332. The flange 334 may define or partition at least one of an upper surface or a lower surface of the compression chamber 331.

According to an embodiment, the flange 334 may include a discharge hole 3341. The discharge hole 3341 may be configured to discharge the compressed refrigerant from the compression chamber 331. The refrigerant discharged through the discharge hole 3341 may be discharged into a space formed inside the case 310.

According to an embodiment, the flange 334 may include a hollow portion 3342 through which the rotation shaft 340 passes. The hollow portion 3342 may be formed in a central portion of the flange 334.

According to an embodiment, the insulation chamber 333 may be formed in the flange 334. The insulation chamber 333 may be formed to be closer to the central side of the flange 334 than to the outer circumferential surface of the flange 334. The insulation chamber 333 may be positioned to be relatively closer to the hollow portion 3342 of the flange 334 than to the outer circumferential surface of the flange 334. However, the position of the insulation chamber 333 is not limited thereto, and the insulation chamber 333 may be formed in the cylinder 332 or a middle plate 336 to be described below.

According to an embodiment, the insulation chamber 333 may be spatially separated from the compression chamber 331 by the flange 334. The insulation chamber 333 and the compression chamber 331 may be spatially separated from each other so that the refrigerant introduced into the compression chamber 331 does not flow toward the insulation chamber 333.

According to an embodiment, the flange 334 may include at least one of a first flange 334a or a second flange 334b. According to an embodiment, the first flange 334a may include a first discharge hole 3341a. The first flange 334a may be positioned above the cylinder 332 and may be referred to as a first flange. The first flange 334a may be disposed to be relatively closer to the discharge port 312 of the case 310 than the second flange 334b. According to an embodiment, the second flange 334b may include a second discharge hole 3341b. However, the disclosure is not limited thereto, and when the compressor 300 is a single rotary compressor unlike that illustrated, the second discharge hole 3341b may be omitted from the second flange 334b.

According to an embodiment, the rolling piston 335 may be disposed in the compression chamber 331. The rolling piston 335 may be disposed in the compression chamber 331 to be eccentric with respect to the rotation shaft 340 and rotate. The rolling piston 335 may rotate with eccentricity by the rotation shaft 340. When the rolling piston 335 is rotated by the rotation shaft 340, the refrigerant introduced into the compression chamber 331 may be compressed. The rolling piston 335 may have, e.g., a cylindrical shape, but is not limited thereto.

According to an embodiment, the compression device 330 may include a bypass flow path 337. The bypass flow path 337 may be configured to communicate between the suction hole 3321 and the insulation chamber 333. A portion of the refrigerant passing through the suction hole 3321 may pass through the bypass flow path 337 and be accommodated in the insulation chamber 333. In other words, the insulation chamber 333 may be a space for accommodating the gaseous refrigerant that has passed through the bypass flow path 337.

According to an embodiment, the bypass flow path 337 may include a first bypass flow path 337a and a second bypass flow path 337b. The first bypass flow path 337a may be formed (or disposed) in the cylinder 332. The first bypass flow path 337a may communicate with the suction hole 3321. The second bypass flow path 337b may be formed (or disposed) in the flange 334. The second bypass flow path 337b may communicate with the insulation chamber 333. The first bypass flow path 337a and the second bypass flow path 337b may be connected to each other.

The temperature of the refrigerant passing through the bypass flow path 337 and accommodated in the insulation chamber 333 may be lower than the temperature of the refrigerant compressed in the compression chamber 331. As the gaseous refrigerant before being compressed into the insulation chamber 333 is accommodated, it may have a relatively higher conductive thermal resistance than the peripheral flange 334. The gaseous refrigerant accommodated in the insulation chamber 333 may reduce the amount of heat outside the compression device 330 introduced into the compression chamber 331. In other words, the degree to which the compression chamber 331 is heated by the temperature outside the compression device 330 may be reduced, thereby increasing the difference between the temperature outside the compression device and the temperature of the compression chamber 331. As the degree to which the temperature of the compression chamber 331 is heated by heat outside the compression device 330 is reduced, the volumetric efficiency of the compressor 300 may be increased.

The refrigerant accommodated in the insulation chamber 333 may be heated by heat outside the compression device 330. As the volume of the refrigerant heated in the insulation chamber 333 expands, the refrigerant may be discharged from the insulation chamber 333 to the suction hole 3321 through the bypass flow path 337. The empty space of the insulation chamber 333 formed by discharging the refrigerant may be filled with the gaseous refrigerant introduced from the accumulator.

According to an embodiment, there may be a plurality of bypass flow paths 337. Each bypass flow path 337 may connect the suction hole 3321 and the insulation chamber 333. By increasing the number of bypass flow paths 337, the refrigerant in the insulation chamber 333 may be more fluidly circulated.

According to an embodiment, the compressor 300 may be a twin rotary compressor as shown. However, this is merely illustrative, and the insulation chamber 333 structure for increasing volumetric efficiency in the disclosure is not limited to the twin rotary compressor. For example, even in the case of a single rotary compressor, as described in the disclosure, an insulation chamber is formed around the outside of the compression chamber.

Hereinafter, a configuration in which the compressor 300 is a twin rotary compressor is described in detail.

According to an embodiment, the cylinder 332 may include at least one of a first cylinder 332a or a second cylinder 332b. The first cylinder 332a and the second cylinder 332b may have substantially the same shape, but are not limited thereto. The first cylinder 332a may be positioned above the second cylinder 332b. The first cylinder 332a may be coupled to the first flange 334a. The second cylinder 332b may be coupled to the second flange 334b. The first cylinder 332a and the second cylinder 332b may be disposed to be spaced apart from each other with a middle plate 336 to be described below therebetween.

According to an embodiment, the compression device 330 may include a middle plate 336. The middle plate 336 may be positioned between the first cylinder 332a and the second cylinder 332b. The middle plate 336 may be provided to spatially separate the first compression chamber 331a formed in the first cylinder 332a from the second compression chamber 331b formed in the second cylinder 332b.

According to an embodiment, although not shown, the insulation chamber 333 may be formed in the middle plate 336.

According to an embodiment, the compression chamber 331 may include at least one of the first compression chamber 331a or the second compression chamber 331b. The first compression chamber 331a may be provided in the first cylinder 332a. The second compression chamber 331b may be provided in the second cylinder 332b.

According to an embodiment, the compression chamber 331 may be an area defined by the cylinder 332, the flange 334, and the middle plate 336. A side surface of the compression chamber 331 may be defined by the inner circumferential surface of the cylinder 332. An upper surface and a lower surface of the compression chamber 331 may be defined by the flange 334 and the middle plate 336.

According to an embodiment, the space of the first compression chamber 331a may be defined or partitioned by the first cylinder 332a, the first flange 334a, and the middle plate 336. For example, a side surface of the first compression chamber 331a is defined or partitioned by the inner circumferential surface of the first cylinder 332a. For example, an upper surface of the first compression chamber 331a is defined or partitioned by the lower surface of the first flange 334a. For example, the lower surface of the first compression chamber 331a is defined or partitioned by the upper surface of the middle plate 336.

According to an embodiment, the space of the second compression chamber 331b may be defined or partitioned by the second cylinder 332b, the middle plate 336, and the second flange 334b. For example, a side surface of the second compression chamber 331b is defined or partitioned by the inner circumferential surface of the second cylinder 332b. For example, an upper surface of the second compression chamber 331b is defined or partitioned by the lower surface of the middle plate 336. For example, the lower surface of the second compression chamber 331b is defined or partitioned by the upper surface of the second flange 334b.

According to an embodiment, the insulation chamber 333 may include a first insulation chamber 333a and a second insulation chamber 333b. The first insulation chamber 333a may be provided (or disposed) in, e.g., the first flange 334a. The second insulation chamber 333b may be provided (or disposed) in, e.g., the second flange 334b. For example, the first insulation chamber 333a reduces the degree to which heat outside the compression device 330 is transferred to the first compression chamber 331a. For example, the second insulation chamber 333b reduces the degree to which heat outside the compression device 330 is transferred to the second compression chamber 331b.

According to an embodiment, the insulation chamber 333 may be formed inside at least one of the first flange 334a, the second flange 334b, the first cylinder 332a, the second cylinder 332b, or the middle plate 336.

According to an embodiment, the rolling piston 335 may include a first rolling piston 335a and a second rolling piston 335b. The first rolling piston 335a may be disposed in the first compression chamber 331a. The second rolling piston 335b may be disposed in the second compression chamber 331b. The first rolling piston 335a and the second rolling piston 335b may be coupled to the rotation shaft 340 to be rotatable by the rotation shaft 340. The first rolling piston 335a and the second rolling piston 335b may be eccentrically rotated to have a phase difference of 180 degrees from each other.

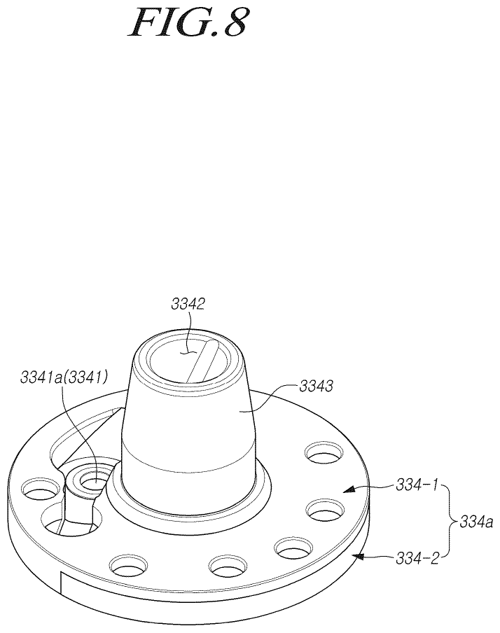

FIG. 8 is a perspective view illustrating a first flange according to an embodiment;

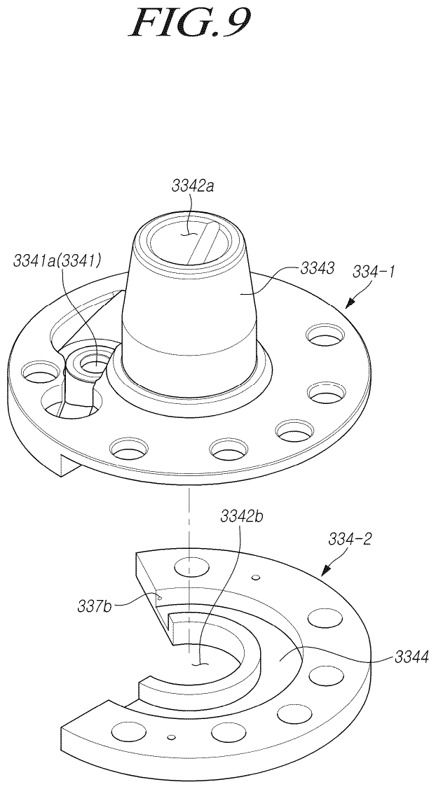

FIG. 9 is an exploded perspective view illustrating a first flange according to an embodiment;

The first flange 334a illustrated in FIGS. 8 and 9 may be substantially the same as or similar to the first flange 334a described with reference to FIGS. 3 to 7. Hereinafter, the same reference numerals are assigned to substantially the same or similar components. The first flange 334a is described with reference to FIGS. 8 and 9, but the following description may also be applied to the second flange 334b.

Referring to FIGS. 8 and 9, the first flange 334a may include a first portion 334-1 and a second portion 334-2. The first flange 334a may be formed by coupling the first portion 334-1 and the second portion 334-2. The first portion 334-1 and the second portion 334-2 may be separately manufactured and coupled to each other, but are not limited thereto, and may be integrally formed. The first portion 334-1 may be coupled to, e.g., an upper portion of the second portion 334-2.

According to an embodiment, the first portion 334-1 may include a first hollow portion 3342a formed in the middle thereof. The first portion 334-1 may include an extension portion 3343 extending upward (or axial direction) from the center. A first hollow portion 3342a may be formed in the middle of the extension portion 3343. The above-described rotation shaft (e.g., the rotation shaft 340 of FIG. 4) may be disposed to pass through the extension portion 3343. A rotation shaft (e.g., the rotation shaft 340 of FIG. 4) may pass through the first hollow portion 3342a.

According to an embodiment, the second portion 334-2 may include a second hollow portion 3342b formed in the middle thereof. The second portion 334-2 may be, e.g., an overall fan-shaped plate. According to an embodiment, the second portion 334-2 may include a chamber groove 3344 for forming a first insulation chamber (e.g., the first insulation chamber 333a of FIG. 4). The chamber groove 3344 may define or divide a lower surface and a side surface of the first insulation chamber 333a. The chamber groove 3344 may be formed to surround the second hollow portion 3342b.

When the first portion 334-1 and the second portion 334-2 are coupled, the first hollow portion 3342a and the second hollow portion 3342b may vertically overlap each other. The first hollow portion 3342a and the second hollow portion 3342b may overlap each other to form one hollow portion. When the first portion 334-1 and the second portion 334-2 are coupled, the upper side of the chamber groove 3344 may be closed by the second portion 334-2. In other words, one surface of the second portion 334-2 may define or partition the upper surface of the first insulation chamber 333a.

The first portion 334-1 and the second portion 334-2 may be coupled to each other to form a first insulation chamber 333a.

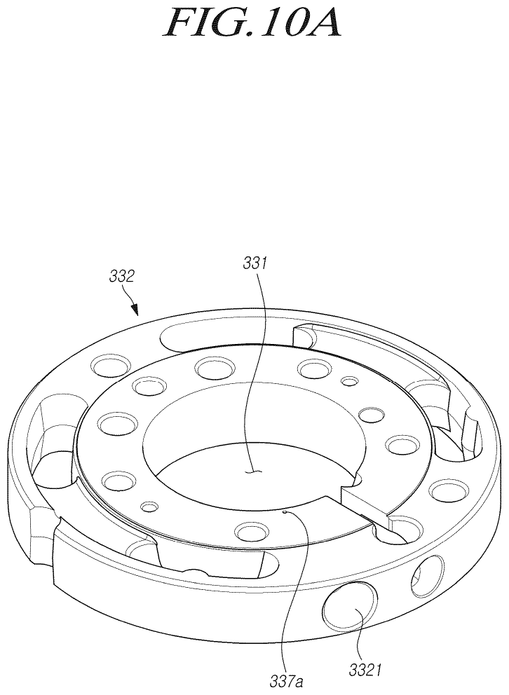

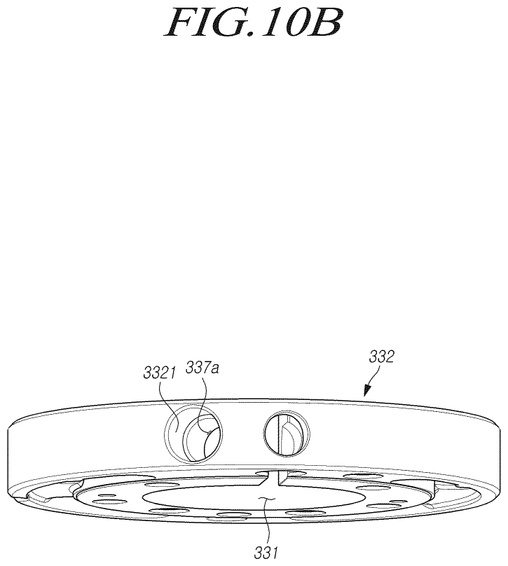

According to an embodiment, the first flange 334a may include a second bypass flow path 337b. The second bypass flow path 337b may extend from the first insulation chamber 333a. The second bypass flow path 337b may communicate with the first insulation chamber 333a. One end of the second bypass flow path 337b may be connected to the first insulation chamber 333a, and the other end of the second bypass flow path 337b may be connected to the outside of the first flange 334a. The other end of the second bypass flow path 337b may be connected to a second bypass flow path (e.g., the second bypass flow path 337b of FIG. 10A).

FIGS. 10A and 10B are perspective views illustrating a first cylinder according to an embodiment.

The first cylinder 332a illustrated in FIGS. 10A and 10B may be substantially the same as or similar to the first cylinder 332a described with reference to FIGS. 3 to 7. Hereinafter, the same reference numerals are assigned to substantially the same or similar components. FIGS. 10A and 10B illustrate the first cylinder 332a, but the following description may also be applied to the second cylinder 332b.

Referring to FIGS. 10A and 10B, the first cylinder 332a may include a first bypass flow path 337a. The first bypass flow path 337a may extend from the suction hole 3321. The first bypass flow path 337a may communicate with the suction hole 3321. One end of the first bypass flow path 337a may be connected to the suction hole 3321, and the other end of the first bypass flow path 337a may be connected to the outside of the first cylinder 332a. The other end of the first bypass flow path 337a may be connected to a second bypass flow path (e.g., the second bypass flow path 337b of FIG. 9).

As the first bypass flow path 337a and the second bypass flow path 337b are connected to each other as illustrated in FIGS. 8, 9, 10A and 10B, part of the gaseous refrigerant passing through the suction hole 3321 may pass through the first bypass flow path 337a and the second bypass flow path 337b to be accommodated in the first insulation chamber 333a.

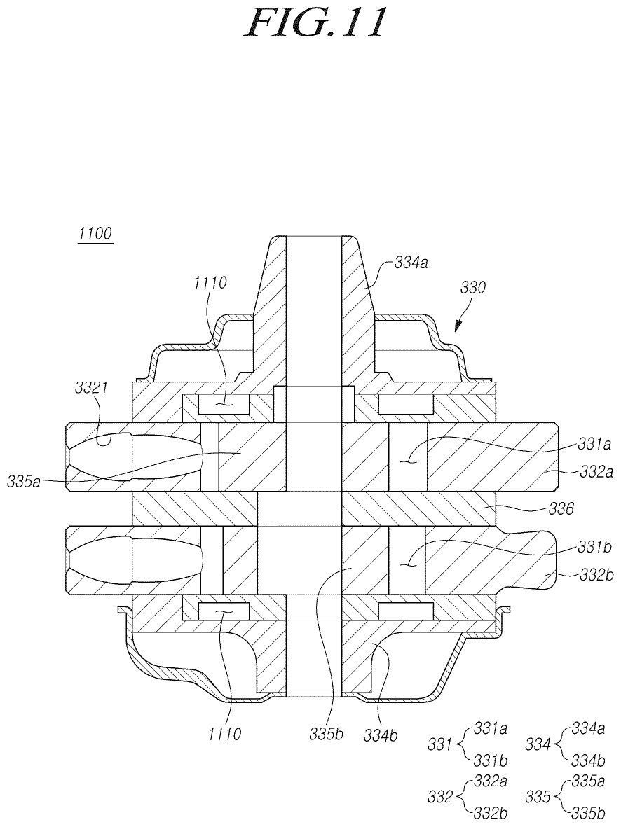

FIG. 11 is a cross-sectional view illustrating a compression device according to an embodiment;

The compression device 1100 illustrated in FIG. 11 may be included in the compressor (e.g., the compressor 300 of FIG. 3) illustrated in FIGS. 3 to 7. The compression device 1100 of FIG. 11 may replace the compression device (e.g., the compression device 330 of FIG. 4) illustrated in FIGS. 3 to 7. Hereinafter, the same reference numerals are used for the components of the compression device 1100 of FIG. 11, which are substantially the same as or similar to the components of the compression device 330 described with reference to FIGS. 3 to 7.

Referring to FIG. 11, the compression device 1100 may include at least one of a cylinder 332, a flange 334, or a rolling piston 335. According to an embodiment, the compression device 1100 may include an insulation chamber 1110.

According to an embodiment, the insulation chamber 1110 may be formed outside the compression chamber 331. The insulation chamber 1110 may be spatially separated from the compression chamber 331. The insulation chamber 1110 may be positioned on, e.g., at least one of an upper side or a lower side of the compression chamber 331. The conductive thermal resistance of the insulation chamber 1110 may be relatively larger than that of the flange 334. The insulation chamber 1110 may be disposed around the compression chamber 331 to increase conductive thermal resistance around the compression chamber 331. For example, the insulation chamber 1110 is formed in the flange 334.

According to an embodiment, the insulation chamber 1110 may be configured to be spatially separated from the suction hole 3321 and the compression chamber 331. The insulation chamber 1110 may be configured to prevent gaseous refrigerant passing through the suction hole 3321 from entering.

According to an embodiment, unlike the compression device (e.g., the compression device 330 of FIG. 4) described with reference to FIGS. 3 to 7, the compression device 1100 illustrated in FIG. 11 may omit a bypass flow path (e.g., the bypass flow path 337 of FIG. 4).

According to an embodiment, the insulation chamber 1110 may be in a vacuum state. According to an embodiment, the insulation chamber 1110 may be configured to be sealed from the outside of the compression device 1100. As the insulation chamber 1110 is configured to maintain a vacuum therein or to be sealed from the outside of the compression device 1100, the insulation chamber 1110 may have a relatively higher conductive thermal resistance than the flange 334 or the cylinder 332. Therefore, as the insulation chamber 1110 is provided (or disposed) on the upper side or the lower side of the compression chamber 331, the degree to which the compression chamber 331 is heated by heat outside the compression device 330 may be reduced.

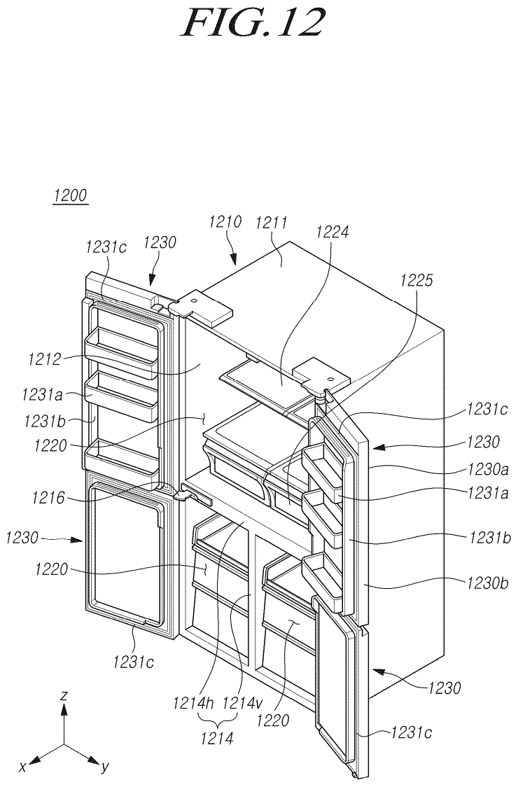

FIG. 12 is a view schematically illustrating an inner/outer appearance of a refrigerator according to an embodiment.

In FIG. 12, a refrigerator 1200, which is one of home appliances, is described as an example.

Referring to FIG. 12, a refrigerator 1200 may include a main body 1210. The main body 1210 may include an outer case 1211 and an inner case 1212 disposed inside the outer case 1211. The outer case 1211 may be disposed to form at least a portion of the outer appearance of the main body 1210. In an example, the outer case 1211 may be configured to include a metal material having excellent durability and aesthetics. The inner case 1212 may be disposed to define a space of the storage compartment 1220. For example, the storage compartment 1220 is provided in the main body 1210.

The inner case 1212 may include a case, a plate, a panel, and/or a liner forming the storage compartment 1220. The inner case 1212 may be formed as a single body or may be formed by assembling a plurality of plates. In an example, the inner case 1212 may be integrally injection-molded using a plastic material, but the disclosure is not limited thereto.

Although not shown, an accommodation space may be formed between the outer case 1211 and the inner case 1212. An insulation material (not shown) for insulating the storage compartment 1220 may be disposed in at least a portion of the accommodation space. The insulation material may insulate the inside of the storage compartment 1220 and the outside of the storage compartment 1220 so that the temperature inside the storage compartment 1220 may be maintained at a set appropriate temperature without being affected by the external environment of the storage compartment 1220.

According to an embodiment, the insulation material may include a foam insulation material. In an example, after fixing the inner case 1212 and the outer case 1211 with a jig or the like, the foam insulation material may be formed by injecting and foaming a urethane foam mixed with polyurethane and a foaming agent into an accommodation space between the inner case 1212 and the outer case 1211. According to an embodiment, the insulation material may include a vacuum insulation material in addition to the foam insulation material or in place of the foam insulation material. The vacuum insulator may include a core material and an outer cover material that receives the core material and seals the inside at a pressure close to vacuum or vacuum. The vacuum insulation material may further include an adsorbent that adsorbs gas and moisture to maintain a stable vacuum state. The insulation material of the refrigerator 1200 is not limited to the foam insulation material or vacuum insulation material described above, but may be configured using various materials that may be used for insulation.

According to an embodiment, the refrigerator 1200 may include a storage compartment 1220. The storage compartment 1220 may store food. Food includes things that may be eaten or drunk, and specifically, may include meat, fish, seafood, fruits, vegetables, water, ice, beverages, kimchi, or alcoholic beverages such as wine. Drugs and cosmetics may be stored in the storage compartment 1220 in addition to food, but there is no limitation on items that may be stored in the storage compartment 1220.

According to an embodiment, the refrigerator 1200 may include one or more storage compartments 1220. When two or more storage compartments 1220 are formed in the refrigerator 1200, each storage compartment may have a different use and may be maintained at a different temperature. To that end, the storage compartments 1220 may be partitioned from each other by a partition wall 1214 including an insulation material. In an example, the storage compartment may be referred to as a “refrigerating compartment”, a “freezing compartment”, or a “variable temperature compartment” according to the use and/or the temperature range. For example, the refrigerating compartment refers to a storage chamber when food is maintained at an appropriate temperature for refrigerating and storing, and the freezing compartment may refer to a storage chamber when food is maintained at an appropriate temperature for freezing and storing. Refrigerating may refer to cooling food to the extent that the food is not frozen, and for example, the refrigerating compartment is maintained in the range of 0 degrees Celsius to 7 degrees Celsius. Freezing may mean freezing food or cooling food to remain frozen, and for example, the freezing compartment is maintained in the range of minus 20 degrees Celsius to minus 1 degree Celsius. The variable temperature compartment may refer to a storage compartment that may be maintained at a predetermined variable temperature by the user's selection or regardless of the user's selection. According to an embodiment, one storage compartment may be provided so that a portion thereof is used as a refrigerating compartment and the remaining portion thereof is used as a freezing compartment. Storage compartments may be referred to by various names such as “vegetable compartment”, “fresh compartment”, “cooling compartment”, and “ice making compartment” in addition to the above-described names such as “refrigeration compartment”, “freezing compartment”, and “variable temperature compartment”.

According to an embodiment, the number, size, and/or shape of the storage compartment 1220 may vary depending on the shape or position of the partition wall 1214. According to an embodiment, the partition wall 1214 may be integrally formed with the main body 1210. According to an embodiment, the partition wall 1214 may be a separate partition provided separately from the main body 1210 and assembled to the main body 1210.

According to an embodiment, the storage compartment 1220 may be partitioned left and right by a vertical partition wall 1214v (a partition wall extending in the vertical direction). The size of the storage compartment 1220 partitioned left and right may vary depending on the position of the vertical partition wall 1214v. For example, the storage compartment 1220 in which the vertical partition wall 1214v is provided in the middle and partitioned left and right is provided in mirror symmetry. According to an embodiment, there may be a plurality of vertical partition walls. When there are a plurality of vertical partition walls, the storage compartment may be divided into three or more storage compartments along the left and right directions.

According to an embodiment, the storage compartment 1220 may be vertically partitioned by a horizontal partition wall 1214h (a partition wall extending in the horizontal direction). The size of the storage compartment 1220 divided vertically may vary depending on the position of the horizontal partition wall 1214h. According to an embodiment, there may be a plurality of horizontal partition walls. When there are a plurality of horizontal partition walls, the storage compartment may be divided into three or more storage compartments in the vertical direction.

The refrigerator may be configured to include a plurality of storage compartments having various sizes and shapes according to various combinations of the vertical partition wall and the horizontal partition wall.

According to an embodiment, a plurality of shelves 1224 and/or a plurality of storage containers 1225 may be provided inside the storage compartment 1220. Each of the plurality of shelves 1224 and the plurality of storage containers 1225 may be separable from an inner space of the storage compartment 1220.

According to an embodiment, each storage compartment 1220 may be formed so that at least one side thereof is open for receiving and receiving food. According to an embodiment, the refrigerator 1200 may include each door 1230 for opening and closing each storage compartment 1220. The storage compartment 1220 may have, e.g., an open front surface. In an example, the door 1230 may be disposed on the front surface of the main body 1210 and the storage compartment 1220 to open and close the storage compartment 1220. The door 1230 may be configured to seal the storage compartment 1220 while the door is closed. Like the main body 1210, the door 1230 may include an insulation material to insulate the storage compartment 1220 from the external environment while the door 1230 is closed.

According to an embodiment, the door 1230 may be configured to be opened and closed by rotating about the hinge 1216, but the disclosure is not limited thereto. In an example, the door may be configured to be opened and closed in a sliding manner.

According to an embodiment, the door 1230 may include a door panel 1230a and/or a door body 1230b. The door panel 1230a and the door body 1230b may be detachably coupled to each other. For example, one side of the door body 1230b is fixed to the main body 1210 by a hinge 1216. The door panel 1230a may form a portion of the front outer appearance of the refrigerator 1200. Accordingly, the door panel 1230a may serve as an important element of aesthetics when the refrigerator 1200 is disposed indoors. The door panel 1230a may have various colors and/or various designs and may be configured to be replaceable so that the user may decorate the front exterior of the refrigerator 1200 according to his/her taste. According to an embodiment, the door panel 1230a and the door body 1230b may be integrally formed.

According to an embodiment, the door 1230 may include a door handle (not shown), a door shelf 1231a, a shelf support 1231b, and/or a gasket 1231c. The user may open and close the door 1230 using the door handle. The door handle may be recessed on the bottom surface or the top surface of the door 1230, or may protrude from the front surface of the door 1230, but is not limited to a specific shape.

The door shelf 1231a may be disposed to accommodate food. The shelf support 1231b may be disposed on both left and right sides of the door shelf 1231a to support the door shelf 1231a. The shelf support 1231b may extend vertically from, e.g., the door 1230. For example, the shelf support 1231b protrudes from the rear surface (the inner surface facing the storage compartment 1220) of the door 1230 toward the storage compartment 1220 and may be disposed to extend in the vertical direction. The shelf support 1231b may be disposed as a separate component separable from the door 1230, or may be integrally formed with the door 1230.

The gasket 1231c may be disposed to surround an edge of the door body 1230b. The gasket 1231c may be disposed to seal a gap between the main body 1210 and the door 1230 in a state in which the door 1230 is closed.

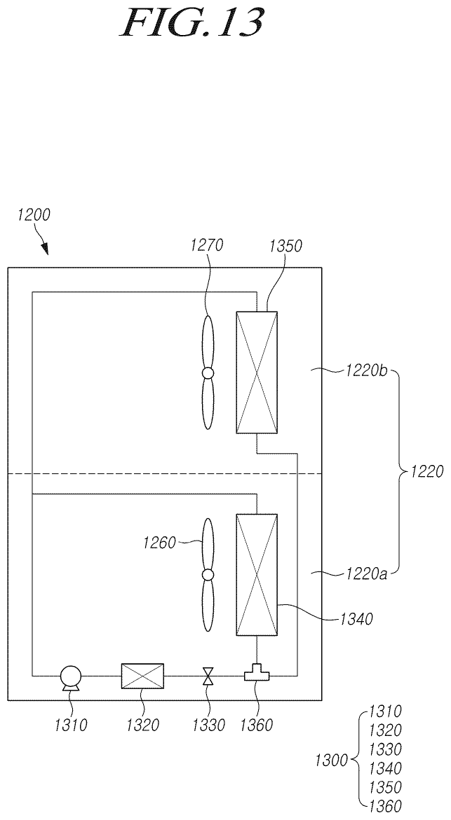

According to an embodiment, the refrigerator 1200 may include a heat pump (e.g., the heat pump 1300 of FIG. 13). The heat pump 1300 may be referred to as a cold air supply device. The heat pump 1300 may include a machine, an instrument, an electronic device, and/or a system combining the machine, the instrument, and the electronic device capable of generating cold air and guiding the generated cold air to the storage compartment to cool the storage compartment. For example, the heat pump 1300 is disposed inside the main body 1210 to supply cold air to each of the storage compartments 1220.

FIG. 13 is a view schematically illustrating a heat pump structure included in a refrigerator according to an embodiment of the disclosure.

The heat pump 1300 illustrated in FIG. 13 may be included in the refrigerator (e.g., the refrigerator 1200 of FIG. 12) of FIG. 12.

Referring to FIG. 13, the refrigerator 1200 may include a heat pump 1300. The heat pump 1300 may include a compressor 1310, a condenser 1320, an expansion device 1330, a first heat exchanger 1340, or a second heat exchanger 1350. The compressor 1310 may be configured to compress the refrigerant. The first heat exchanger 1340 may perform heat exchange between the freezing compartment 1220a and the refrigerant. The second heat exchanger 1350 may perform heat exchange between the refrigerating path and the refrigerant. The expansion device 1330 may be configured to decompress the refrigerant.

According to an embodiment, the refrigerator 1200 may include a freezing compartment 1220a and a refrigerating compartment 1220b divided with respect to a partition wall. The storage compartment 1220 may include a freezing compartment 1220a and a refrigerating compartment 1220b. Freezing may mean freezing food or cooling food to remain frozen, and for example, the freezing compartment 1220a is maintained in the range of minus 20 degrees Celsius to minus 1 degree Celsius. Refrigerating may refer to cooling food to the extent that the food is not frozen, and for example, the refrigerating compartment 1220b is maintained in the range of 0 degrees Celsius to 7 degrees Celsius.

Here, the first heat exchanger 1340 may be a heat exchanger for cooling the freezing compartment 1220a. The first heat exchanger 1340 may include an evaporator. Here, the second heat exchanger 1350 may be a heat exchanger for cooling the refrigerating compartment 1220b. The second heat exchanger 1350 may include an evaporator.

A series of cycles in which the refrigerant flows through the compressor 1310, the condenser 1320, the expansion device 1330, and the first heat exchanger 1340 may be referred to as a “freezing cycle”. A series of cycles in which the refrigerant flows through the compressor 1310, the condenser 1320, the expansion device 1330, and the second heat exchanger 1350 may be referred to as a “refrigerating cycle”.

According to an embodiment, the refrigerator 1200 may include a switching valve 1360. According to an embodiment, the heat pump 1300 may include a switching valve 1360. The switching valve 1360 may be disposed to adjust the refrigerant passing through the expansion device 1330 to flow to any one of the first heat exchanger 1340 and the second heat exchanger 1350. The switching valve 1360 may be, e.g., a three-way valve, but is not limited thereto.

According to an embodiment, the refrigerator 1200 may further include a first blower fan 1260. The first blower fan 1260 may be disposed to blow air to the first heat exchanger 1340. The first blower fan 1260 may be disposed for heat exchange between the air in the freezing compartment 1220a and the first heat exchanger 1340.

According to an embodiment, the refrigerator 1200 may further include a second blower fan 1270. The second blower fan 1270 may be disposed to blow air to the second heat exchanger 1350. The second blower fan 1070 may be disposed for heat exchange between the air in the refrigerating compartment 1220b and the second heat exchanger 1350.

According to an embodiment, the compressor 1310 may operate by receiving electrical energy from an external power source. The compressor 1310 may include a compressor motor (e.g., the driving device 320 of FIG. 4), and may compress a low-pressure gaseous refrigerant to a high pressure using the rotational force of the compressor motor (e.g., the driving device 320 of FIG. 4).

According to an embodiment, the compressor 1310 may be substantially the same as or similar to the compressor (e.g., the compressor 300 of FIG. 3) illustrated in FIGS. 3 to 9, 10A, 10B, and 11. The structure of the compressor 300 with enhanced volumetric efficiency has been described above with reference to FIGS. 3 to 9, 10A, 10B, and 11, and a detailed description of the compressor 1310 is omitted.

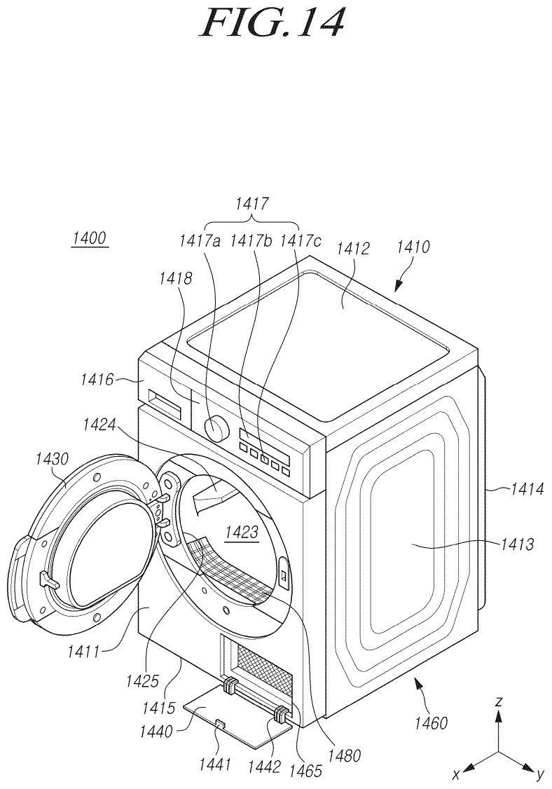

FIG. 14 is a front perspective view illustrating a clothing dryer according to an embodiment.

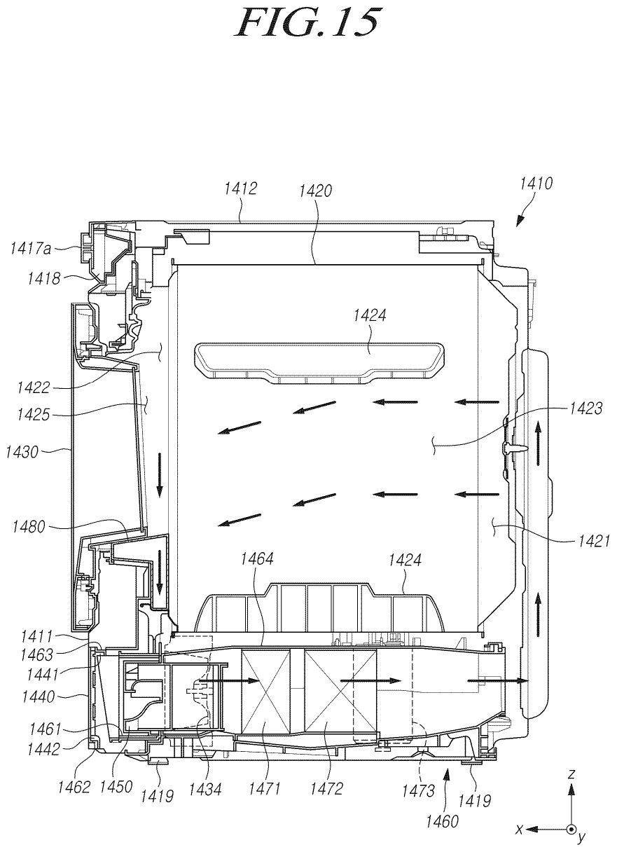

FIG. 15 is a cross-sectional view illustrating a clothing dryer according to an embodiment. In other words, FIG. 15 is a cross-sectional view taken in parallel to plane x-z of FIG. 14.

In FIGS. 14 and 15, a clothing dryer 1400, which is one of home appliances, is described as an example.

Referring to FIGS. 14 and 15, the direction along the x-axis may be defined as a front and rear direction of the clothing dryer 1400, the direction along the y-axis may be defined as a left and right direction of the clothing dryer 1400, and the direction along the z-axis may be defined as a vertical direction of the clothing dryer 1400. The terms “front and rear direction”, “left and right direction”, and “upper and lower direction” to be used below are defined with respect to the illustrated drawings, and the shape and position of each component are not limited thereto.

According to an embodiment, the clothing dryer 1400 may heat air circulating therein to dry the dried object. The clothing dryer 1400 may be divided into a heater type, a heat pump type, or a hybrid type based on the method of heating air. The hybrid type may heat air, e.g., using the heater type and the heat pump type together or alternately. It is assumed that the clothing dryer 1400 to be described in the disclosure is of a hybrid type.

According to an embodiment, the clothing dryer 1400 may include a main body 1410. The main body 1410 may form an exterior of the clothing dryer 1400. The main body 1410 may be formed of at least one of metal or plastic. The clothing dryer 1400 may be provided in various shapes, but may be provided in a substantially rectangular parallelepiped shape.

According to an embodiment, the main body 1410 may include a front cover 1411, an upper cover 1412, a left/right side cover 1413, a rear cover 1414, or a lower cover 1415. The components included in the main body 1410 may be configured individually or integrally. For example, the left/right side cover 1413 and the rear cover 1414 included in the main body 1410 is integrally formed to form a side and rear cover. The front cover 1411, upper cover 1412, left/right side cover 1413, rear cover 1414, or lower cover 1415 included in the main body 1410 may form an internal housing. The inner housing may include an inner space in which various components constituting the clothing dryer 1400 may be stored or mounted.

According to an embodiment, a water container 1416 may be disposed in the main body 1410. The water container 1416 may be disposed at an upper portion of the main body 1410. The water container 1416 may be assembled in a recessed portion formed at a point of an upper portion of the front cover 1411. The water container 1416 may be detachably fixed from the recessed portion. The water container 1416 may be disposed to collect condensate generated by the refrigerant cycle of the clothing dryer 1400.

According to an embodiment, the main body 1410 may include an input/output unit 1417. The input/output unit 1417 may include an input units 1417a and 1117c for receiving a user input and an output unit 1417b for visually or audibly transferring information to the user. The output unit 1417b may be implemented as a display 1417b.

According to an embodiment, the input/output unit 1417 may be positioned on the panel 1418 positioned on the upper end of the main body 1410. A circuit board may be disposed on the rear surface of the panel 1418. The circuit board may be positioned inside the clothes dryer 1400. The display 1417b or sensors may be mounted in at least a partial space formed on the circuit board. A processor constituting the controller may be mounted in at least a partial space formed on the circuit board.

According to an embodiment, the input unit may include a dial button 1417a. The dial button 1417a may be implemented as a dial or a jog shuttle. The dial button 1417a may have a wheel structure. The dial button 1417a may receive a user input by rotating clockwise or counterclockwise.

According to an embodiment, the input unit may include a button 1417c. The button 1417c may receive a user input by touching or pressing. The button 1417c may detect the user's touch in a capacitive or resistive manner, or may detect an input by physical pressing.

According to an embodiment, the output unit may include a display 1417b. The display 1417b may visually output information to be transferred to the user. Although not shown, the output unit may include a speaker. The speaker may audibly output information to be transferred to the user.

According to an embodiment, the main body 1410 may include a base 1460. The base 1460 may be disposed under the main body 1410 to form a lower cover 1415. For example, the base 1460 forms a bottom surface in the inner housing of the main body 1410. A leg 1419 for supporting the main body 1410 may be disposed on the lower cover 1415. The leg 1419 may separate the main body 1410 from the bottom surface by a predetermined distance. For example, a plurality of legs 1419 is disposed on the lower cover 1415 to stably support the main body 1410.

According to an embodiment, the clothing dryer 1400 may include a drum 1420 disposed in the inner housing to accommodate the object to be dried. The drum 1420 may include an entrance of the drum into which the dried object is put. The entrance of the drum may be defined as a first opening 1425. The drum 1420 may be rotatably disposed in the inner housing of the main body 1410.

According to an embodiment, the drum 1420 may include a suction hole 1421 through which air flows into the drum 1423 and an discharge hole 1422 through which air flows out of the drum 1423. The suction hole 1421 may be formed on one side of the drum 1420, and the discharge hole 1422 may be formed on the other side of the drum 1420. The suction hole 1421 may be, e.g., a rear opening of the drum 1420. The discharge hole 1422 may be, e.g., a front opening (e.g., the first opening 1425) of the drum 1420. For example, the front opening of the drum 1420 is an entrance of the drum.

According to an embodiment, hot and dry air may be introduced into the drum 1420 through the suction hole 1421 to dry the dried object accommodated in the drum 1420. Air used for drying the dried object may escape out of the drum 1420 through the discharge hole 1422. The air exiting the drum 1420 through the discharge hole 1422 may contain a large amount of moisture.

According to an embodiment, a plurality of lifters 1424 may be disposed inside the drum 1420. The lifter 1424 may raise or drop the dried object to contact hot air while the dried object is floating in the space inside the drum 1420.

According to an embodiment, a door 1430 for opening and closing the first opening 1425 may be installed on the front surface of the main body 1410. The door 1430 may be hinged to one side of the first opening 1425 to be rotatable.

According to an embodiment, the base 1460 may be disposed under the drum 1420. A heat pump 1470 forming a refrigerant cycle may be seated on the base 1460. The heat pump 1470 may include an evaporator 1471, a condenser 1472, a compressor 1473, or an expansion device 1474. Further, the blower fan 1434 or the driving motor 1431 may be seated on the base 1460. For example, the base cover 1464 forms a duct structure together with the base 1460.

According to an embodiment, the blower fan 1434 may be disposed on the base 1460. The blower fan 1434 may generate a blowing force based on the power transferred by the driving motor to form a flow path of air. For example, the blower fan 1434 discharges air radially. To that end, the blower fan 1434 may include a rotation shaft formed in a central portion and a plurality of blades formed in a circumferential direction about the rotation shaft.

According to an embodiment, the blower fan 1434 may be applied as various types of fans, but may be implemented as, e.g., a sirocco fan. The blower fan 1434 implemented as a sirocco fan may have different wind speeds corresponding to the rotation directions. For example, the wind speed when the blower fan 1434 rotates clockwise (counterclockwise) is faster than the wind speed when the blower fan 1434 rotates counterclockwise (clockwise).

According to an embodiment, a refrigerant cycle for heating and condensing air may be formed by the heat pump 1470. The refrigerant cycle may correspond to a series of circulation processes including compression-condensation-expansion-evaporation. The main body 1410 may include an evaporator 1471, a condenser 1472, a compressor 1473, and an expansion device 1474 to form a refrigerant cycle. The evaporator 1471 and the condenser 1472 may exchange heat with air. The evaporator 1471 and the condenser 1472 may be collectively referred to as a heat exchanger.

According to an embodiment, the compressor 1473 may operate by receiving electrical energy from an external power source. The compressor 1473 may include a compressor motor (e.g., the driving device 320 of FIG. 4), and may compress a low-pressure gaseous refrigerant to a high pressure using the rotational force of the compressor motor (e.g., the driving device 320 of FIG. 4).

According to an embodiment, the compressor 1473 may be substantially the same as or similar to the compressor (e.g., the compressor 300 of FIG. 3) illustrated in FIGS. 3 to 9, 10A, 10B, and 11. A structure of a compressor (e.g., the compressor 300 of FIG. 3) having enhanced volumetric efficiency has been described above with reference to FIGS. 3 to 9, 10A, 10B, and 11, and a detailed description of the compressor 1473 is omitted.

According to an embodiment, while the clothing dryer 1400 performs a drying cycle or an anti-wrinkle cycle, a closed flow path may be formed inside the main body 1410. Here, the closed flow path may be understood as a movement path (see arrow in FIG. 15) of air formed to circulate air inside the drum 1420 through the heat pump 1470 and the drum 1420. The closed flow path may form a flow path so that air outside the main body 1410 does not flow into the drum 1420 or air inside the drum 1420 does not flow out of the main body 1410. In other words, the flow of air may form a closed loop.

According to an embodiment, the clothing dryer 1400 may include a first filter unit 1480 detachably mounted on a passage through which air circulates. The first filter unit 1480 may include a filter member for filtering foreign substances such as lint flowing together with air circulating inside the drum 1420. The filter member may include at least one of a wool material, a synthetic resin, or a steel material. The filter member may be mounted on a filter frame constituting the outer appearance of the first filter unit 1480.

According to an embodiment, the first filter unit 1480 may be detachable/mounted in the filter duct. The filter duct may be formed as a portion corresponding to a lower portion of the first opening 1425 of the drum 1420 is cut or recessed. The filter duct may form an injection hole through which the first filter unit 1480 is to be inserted. The filter duct may be disposed on a flow path through which air circulates during the drying operation.

According to an embodiment, the first filter unit 1480 may collect foreign substances generated when the clothing dryer 1400 performs a drying operation. The user may remove foreign substances collected by detaching the first filter unit 1480 and mount the cleaned first filter unit 1480 to the filter duct.

According to an embodiment, the clothing dryer 1400 may include a second opening 1465 formed on the front surface of the main body 1410 to access the heat exchanger. The second filter unit 1450 may be mounted inside the main body 1410 through the second opening 1465. The second filter unit 1450 may be detachably mounted on the unit accommodating portion 1461 formed inside the main body 1410 through the second opening 1465. Although not shown, a dehumidification unit may be mounted on the unit accommodating portion 1461. The dehumidification unit may be disposed by the clothing dryer 1400 to remove moisture contained in the outside air. In other words, the second filter unit 1450 or the dehumidification unit may be mounted on the unit accommodating portion 1461, and the dehumidification unit and the second filter unit 1450 may be provided to be replaceable. A unit cover 1440 for opening and closing the second opening 1465 may be disposed on the front surface of the main body 1410.

, when the dehumidification unit 1490 is mounted on the unit accommodating portion 1461, the clothing dryer 1400 performs a dehumidification operation for dehumidifying the surrounding space. The second opening 1465 may be opened while the clothing dryer 1400 performs a dehumidification operation.

For example, when the second filter unit 1450 is mounted on the unit accommodating portion 1461, the clothing dryer 1400 performs a drying operation for drying the object to be dried, such as clothes. While the clothing dryer 1400 performs a drying operation, the second opening 1465 may be closed.

According to an embodiment, in a state in which the unit cover 1440 closes the second opening 1465, the front surface of the unit cover 1440 and the front cover 1411 of the main body 1410 may be connected to each other to form a surface smoothly connected without a step. The user may remove foreign substances including lint or dust attached to the heat pump 1470 through the second opening 1465.

According to an embodiment, the unit cover 1440 may include a coupling protrusion 1441. The coupling protrusion 1441 may protrude from an inner surface of the unit cover 1440. The main body 1410 may include a coupling groove 1463 corresponding to the coupling protrusion 1441. When the coupling protrusion 1441 and the coupling groove 1463 are coupled, the unit cover 1440 may be in a closed state. However, the disclosure is not limited thereto, and the main body 1410 and the coupling protrusion 1441 may be integrally formed, and the unit cover 1440 and the coupling groove 1463 may be integrally formed. In other words, the coupling of the main body 1410 and the unit cover 1440 may be modified in various forms.

According to an embodiment, the unit cover 1440 may include a coupling hinge 1442 that provides a rotation shaft to rotate with respect to the main body 1410. The coupling hinge 1442 may be disposed below the unit cover 1440. The main body 1410 may include a coupling hinge mounting portion 1462 corresponding to the coupling hinge 1442. The coupling hinge 1442 may be coupled to the coupling hinge mounting portion 1462 to rotate, and by such rotation, a space in which the dehumidification unit 1490 or the second filter unit 1450 is mounted, i.e., the unit accommodating portion 1461, may be opened or closed.

According to an embodiment, the second filter unit 1450 may be detachably mounted on the clothing dryer 1400. The second filter unit 1450 may be detachably mounted inside the main body 1410 through the second opening 1465. The second filter unit 1450 may further collect foreign substances that are not filtered by the first filter unit 1480, including a filter member. The second filter unit 1450 may be mounted on or separated from the unit accommodating portion 1461. The second filter unit 1450 may prevent or reduce air from escaping from the closed flow path. In other words, the second filter unit 1450 may prevent or reduce the drying efficiency of the clothing dryer 1400 from deteriorating. The second filter unit 1450 may be disposed on the base 1460.

A home appliance (i.e., air conditioner 200), (i.e., refrigerator 1200), or (i.e., clothing dryer 1400) according to an embodiment may comprise a compressor 300 configured to compress a refrigerant, and a heat pump 230, 1300, or 1470 including a heat exchanger configured to condense or evaporate the refrigerant using the refrigerant compressed by the compressor 300. The compressor 300 may include a case 310 including a suction port 311 and a discharge port 312, a compression device 330 configured to compress the refrigerant introduced from the suction port 311, and a driving device 320 disposed on one side of the compression device 330 and configured to drive the compression device 330. The compression device 330 may include a compression chamber 331 providing a space in which the refrigerant is compressed, a suction hole 3321 communicating with the suction port 311, and an insulation chamber 333 positioned outside the compression chamber 331 to be spatially separated from the compression chamber 331.

According to an embodiment, the compression device 330 may further include a bypass flow path 337 configured to communicate the suction hole 3321 with the insulation chamber.

According to an embodiment, the insulation chamber 333 may be a space in which a portion of the refrigerant passing through the suction hole 3321 passes through the bypass flow path 337 and is accommodated.

According to an embodiment, the insulation chamber 333 may be in a vacuum state.

According to an embodiment, the insulation chamber 333 may be configured to be sealed from an outside of the compression device.

According to an embodiment, the compression device 330 may include a cylinder 332 including the suction hole 3321 and configured to have the compression chamber 331 formed therein, and a flange 334 configured to be coupled to the cylinder 332 and including a discharge hole 3341 formed to discharge the refrigerant compressed in the compression chamber 331. The insulation chamber 333 may be formed inside the flange 334.

According to an embodiment, the compression device 330 may further include a bypass flow path 337 configured to communicate with the suction hole 3321 and the insulation chamber. The bypass flow path 337 may include a first bypass flow path 337a positioned in the cylinder 332 and configured to communicate with the suction hole 3321, and a second bypass flow path 337b positioned in the flange 334 and configured to communicate with the refrigerant insulation chamber 333. The first bypass flow path 337a and the second bypass flow path 337b may be connected to each other.

According to an embodiment, the compressor 300 may include a rolling piston 335 disposed in the compression chamber 331, and a rotation shaft 340 configured to transfer a rotational force of the driving device 320 to the rolling piston 335. The flange 334 may include a hollow portion 3342 through which the rotation shaft 340 passes. The insulation chamber 333 may be positioned to be relatively closer to the hollow portion 3342 than to an outer circumferential surface of the flange 334.

According to an embodiment, a conductive thermal resistance of the insulation chamber 333 may be relatively greater than a conductive thermal resistance of the flange 334.

According to an embodiment, the insulation chamber 333 may be positioned on at least one of an upper side or a lower side of the compression chamber 331.

A compressor 300 according to an embodiment may comprise a case 310 including a suction port 311 and a discharge port 312, a compression device 330 configured to compress the refrigerant introduced from the suction port 311, and a driving device 320 disposed on one side of the compression device 330 and configured to drive the compression device 330. The compression device 330 may include a compression chamber 331 providing a space in which the refrigerant is compressed, a suction hole 3321 communicating with the suction port 311, and an insulation chamber 333 positioned outside the compression chamber 331 to be spatially separated from the compression chamber 331.

According to an embodiment, the compression device 330 may further include a bypass flow path 337 configured to communicate the suction hole 3321 with the insulation chamber.

According to an embodiment, the insulation chamber 333 may be a space in which a portion of the refrigerant passing through the suction hole 3321 passes through the bypass flow path 337 and is accommodated.

According to an embodiment, the insulation chamber 333 may be in a vacuum state.

According to an embodiment, the insulation chamber 333 may be configured to be sealed from an outside of the compression device.

According to an embodiment, the compression device 330 may include a cylinder 332 including the suction hole 3321 and configured to have the compression chamber 331 provided therein, and a flange 334 configured to be coupled to the cylinder 332 and including a discharge hole 3341 formed to discharge the refrigerant compressed in the compression chamber 331. The insulation chamber 333 may be formed inside the flange 334.

According to an embodiment, the compression device 330 may further include a bypass flow path 337 configured to communicate with the suction hole 3321 and the insulation chamber. The bypass flow path 337 may include a first bypass flow path 337a positioned in the cylinder 332 and configured to communicate with the suction hole 3321, and a second bypass flow path 337b positioned in the flange 334 and configured to communicate with the refrigerant insulation chamber 333. The first bypass flow path 337a and the second bypass flow path 337b may be connected to each other.

According to an embodiment, the compressor 300 may include a rolling piston 335 disposed in the compression chamber 331, and a rotation shaft 340 configured to transfer a rotational force of the driving device 320 to the rolling piston 335. The flange 334 may include a hollow portion 3342 through which the rotation shaft 340 passes. The insulation chamber 333 may be positioned to be relatively closer to the hollow portion 3342 than to an outer circumferential surface of the flange 334.

According to an embodiment, a conductive thermal resistance of the insulation chamber 333 may be relatively greater than a conductive thermal resistance of the flange 334.

According to an embodiment, the insulation chamber 333 may be positioned on at least one of an upper side or a lower side of the compression chamber 331. According to an embodiment, the insulation chamber 333 is disposed around the compression chamber 331 to increase conductive thermal resistance around the compression chamber 331.

In the disclosure, the above-described description has been made mainly of specific embodiments, but the disclosure is not limited to such specific embodiments, but should rather be appreciated as covering all various modifications, equivalents, and/or substitutes of various embodiments.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A home appliance comprising:
a compressor configured to compress a refrigerant; and
a heat pump including a heat exchanger configured to condense or evaporate the refrigerant using the refrigerant compressed by the compressor,
wherein the compressor comprises:
a case including a suction port and a discharge port,
a compression device configured to compress the refrigerant introduced from the suction port, and
a driving device disposed on one side of the compression device and configured to drive the compression device, and
wherein the compression device comprises:
a compression chamber providing a space in which the refrigerant is compressed,
a suction hole communicating with the suction port, and
an insulation chamber positioned outside the compression chamber to be spatially separated from the compression chamber.

2. The home appliance of claim 1, wherein the compression device further includes a bypass flow path configured to communicate the suction hole with the insulation chamber.

3. The home appliance of claim 2, wherein the insulation chamber is a space in which a portion of the refrigerant passing through the suction hole passes through the bypass flow path and is accommodated.

4. The home appliance of claim 1, wherein the insulation chamber is in a vacuum state.

5. The home appliance of claim 1, wherein the insulation chamber is configured to be sealed from an outside of the compression device.

6. The home appliance of claim 1,
wherein the compression device further comprises:
a cylinder including the suction hole and configured to form the compression chamber therein, and
a flange configured to be coupled to the cylinder and including a discharge hole formed to discharge the refrigerant compressed in the compression chamber, and
wherein the insulation chamber is formed inside the flange.

7. The home appliance of claim 6,
wherein the compression device further comprises a bypass flow path configured to communicate with the suction hole and the insulation chamber,
wherein the bypass flow path comprises:
a first bypass flow path positioned in the cylinder and configured to communicate with the suction hole, and
a second bypass flow path positioned in the flange and configured to communicate with a refrigerant insulation chamber, and
wherein the first bypass flow path and the second bypass flow path are connected to each other.

8. The home appliance of claim 7,
wherein the compressor further comprises:
a rolling piston disposed in the compression chamber, and
a rotation shaft configured to transfer a rotational force of the driving device to the rolling piston,
wherein the flange includes a hollow portion through which the rotation shaft passes, and
wherein the insulation chamber is positioned to be relatively closer to the hollow portion than to an outer circumferential surface of the flange.

9. The home appliance of claim 8, wherein a conductive thermal resistance of the insulation chamber is relatively greater than a conductive thermal resistance of the flange.

10. The home appliance of claim 9, wherein the insulation chamber is positioned on at least one of an upper side or a lower side of the compression chamber.

11. A compressor, comprising:
a case comprising a suction port and a discharge port;
a compression device configured to compress a refrigerant introduced from the suction port; and
a driving device disposed on one side of the compression device and configured to drive the compression device,
wherein the compression device comprises:
a compression chamber providing a space in which the refrigerant is compressed,
a suction hole communicating with the suction port, and
an insulation chamber positioned outside the compression chamber to be spatially separated from the compression chamber.

12. The compressor of claim 11, wherein the compression device further includes a bypass flow path configured to communicate the suction hole with the insulation chamber.

13. The compressor of claim 12, wherein the insulation chamber is a space in which a portion of the refrigerant passing through the suction hole passes through the bypass flow path and is accommodated.

14. The compressor of claim 11, wherein the insulation chamber is in a vacuum state.

15. The compressor of claim 11, wherein the insulation chamber is configured to be sealed from an outside of the compression device.

16. The compressor of claim 11,
wherein the compression device further comprises:
a cylinder including the suction hole and configured to have the compression chamber provided therein, and
a flange configured to be coupled to the cylinder and including a discharge hole formed to discharge the refrigerant compressed in the compression chamber, and
wherein the insulation chamber is formed inside the flange.

17. The compressor of claim 16,
wherein the compression device further comprises a bypass flow path configured to communicate with the suction hole and the insulation chamber,
wherein the bypass flow path includes:
a first bypass flow path positioned in the cylinder and configured to communicate with the suction hole, and
a second bypass flow path positioned in the flange and configured to communicate with a refrigerant insulation chamber, and
wherein the first bypass flow path and the second bypass flow path are connected to each other.

18. The compressor of claim 16, further comprising:
a rolling piston disposed in the compression chamber; and
a rotation shaft configured to transfer a rotational force of the driving device to the rolling piston,
wherein the flange includes a hollow portion through which the rotation shaft passes, and
wherein the insulation chamber is positioned to be relatively closer to the hollow portion than to an outer circumferential surface of the flange.

19. The compressor of claim 18, wherein a conductive thermal resistance of the insulation chamber is relatively greater than a conductive thermal resistance of the flange.

20. The compressor of claim 19, wherein the insulation chamber is positioned on at least one of an upper side or a lower side of the compression chamber, and
wherein the insulation chamber is disposed around the compression chamber to increase conductive thermal resistance around the compression chamber.
